(19) United States
(12) Patent Application Publication
(10) Pub. No.: US 2026/0223154 A1
(43) Pub. Date: Jul. 30, 2026

(54) INTERFERENCE PATTERN MEASUREMENT AND SIGNALING

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US); Morteza SOLTANI, San Diego, CA (US)

(21) Appl. No.: 19/041,181

(22) Filed: Jan. 30, 2025

(51) Int. Cl. H04W 72/541; H04L 5/00; H04W 72/21

(52) U.S. Cl. CPC H04W 72/541; H04L 5/0051; H04W 72/21

(57) ABSTRACT

Methods, systems, and devices for wireless communications are described. A user equipment (UE) may detect one or more signals that interfere with a downlink transmission (e.g., a physical downlink shared channel (PDSCH) transmission), and the UE may determine an interference pattern associated with the interfering signals. For example, the UE may use one or more algorithms to determine the interference pattern over multiple slots. The UE may transmit a reporting message that includes an indication of the interference pattern. In some examples, the transmission of the reporting message may be based on received signaling (e.g., signaling received from a network entity), based on one or more event triggers, based on a periodicity, or any combination thereof. The UE may receive, from a network entity, a configuration of one or more covariance matrix estimation reference signals, where the configuration may be based on the interference pattern indicated by the reporting message.

### FIELD OF TECHNOLOGY

The following relates to wireless communications, including interference pattern measurement and signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include detecting one or more signals that interfere with a message received via a physical downlink channel, performing, for a set of multiple symbol periods associated with the physical downlink channel, one or more interference covariance matrix estimation computations based on the one or more signals, where one or more interference patterns across the set of multiple symbol periods is based on the one or more interference covariance matrix estimation computations for the one or more signals, and transmitting, to a network entity, a reporting message including information indicative the one or more interference patterns.

An apparatus for wireless communications at a UE is described. The apparatus may include one or more processors and instructions stored in one or more memories and executable by the one or more processors, individually or collectively, to cause the apparatus to detect one or more signals that interfere with a message received via a physical downlink channel, perform, for a set of multiple symbol periods associated with the physical downlink channel, one or more interference covariance matrix estimation computations based on the one or more signals, where one or more interference patterns across the set of multiple symbol periods is based on the one or more interference covariance matrix estimation computations for the one or more signals, and transmit, to a network entity, a reporting message including information indicative the one or more interference patterns.

A UE for wireless communications is described. The UE may include means for detecting one or more signals that interfere with a message received via a physical downlink channel, means for performing, for a set of multiple symbol periods associated with the physical downlink channel, one or more interference covariance matrix estimation computations based on the one or more signals, where one or more interference patterns across the set of multiple symbol periods is based on the one or more interference covariance matrix estimation computations for the one or more signals, and means for transmitting, to a network entity, a reporting message including information indicative the one or more interference patterns.

A non-transitory computer-readable medium storing code for wireless communications is described. The code may include instructions executable by one or more processors to detect one or more signals that interfere with a message received via a physical downlink channel, perform, for a set of multiple symbol periods associated with the physical downlink channel, one or more interference covariance matrix estimation computations based on the one or more signals, where one or more interference patterns across the set of multiple symbol periods is based on the one or more interference covariance matrix estimation computations for the one or more signals, and transmit, to a network entity, a reporting message including information indicative the one or more interference patterns.

In some examples of the method, apparatus, UE, and non-transitory computer-readable medium described herein, the information indicative the one or more interference patterns includes one or more time-domain averaging boundaries associated with the one or more interference covariance matrix estimation computations.

In some examples of the method, apparatus, UE, and non-transitory computer-readable medium described herein, the information indicative the one or more interference patterns includes a bitmap indicating the one or more time-domain averaging boundaries for the set of multiple symbol periods.

In some examples of the method, apparatus, UE, and non-transitory computer-readable medium described herein, transmitting the reporting message may include operations, features, means, or instructions for transmitting the reporting message in accordance with a periodicity.

Some examples of the method, apparatus, UE, and non-transitory computer-readable medium described herein may further include operations, features, means, or instructions for receiving, from the network entity, one or more messages that trigger a transmission of the reporting message, where the reporting message may be transmitted in accordance with the one or more messages.

In some examples of the method, apparatus, UE, and non-transitory computer-readable medium described herein, the one or more messages include downlink control information, medium access control (MAC) control element messages, or any combination thereof.

In some examples of the method, apparatus, UE, and non-transitory computer-readable medium described herein, transmitting the reporting message may include operations, features, means, or instructions for transmitting the reporting message in accordance with one or more event triggers being satisfied, where the one or more event triggers may be based on monitoring the one or more interference patterns.

Some examples of the method, apparatus, UE, and non-transitory computer-readable medium described herein may further include operations, features, means, or instructions for monitoring for the one or more signals during one or more interference measurement windows, where the one or more signals may be detected in accordance with the monitoring.

Some examples of the method, apparatus, UE, and non-transitory computer-readable medium described herein may further include operations, features, means, or instructions for receiving, from the network entity, one or more control messages indicating a configuration of the one or more interference measurement windows, where the monitoring may be based on the configuration.

Some examples of the method, apparatus, UE, and non-transitory computer-readable medium described herein may further include operations, features, means, or instructions for monitoring for the one or more signals during an interference measurement window, where the one or more signals may be detected in accordance with the monitoring, and where the interference measurement window ends a first time offset before transmitting the reporting message.

In some examples of the method, apparatus, UE, and non-transitory computer-readable medium described herein, a beginning of the interference measurement window starts a second time offset after one or more event triggers may be satisfied.

Some examples of the method, apparatus, UE, and non-transitory computer-readable medium described herein may further include operations, features, means, or instructions for receiving, from the network entity, a control message indicating a configuration for a set of multiple reference signals associated with estimation of an interference covariance matrix, where the configuration may be based on the one or more interference patterns.

In some examples of the method, apparatus, UE, and non-transitory computer-readable medium described herein, the configuration may be for a link of a set of one or more links, the configuration including one or more time-domain locations of the set of multiple reference signals, a time density of the set of multiple reference signals, a frequency density of the set of multiple reference signals, one or more offsets associated with the set of multiple reference signals, or any combination thereof.

In some examples of the method, apparatus, UE, and non-transitory computer-readable medium described herein, the configuration may be from a set of multiple configurations for the set of multiple reference signals.

In some examples of the method, apparatus, UE, and non-transitory computer-readable medium described herein, the control message includes downlink control information or a radio resource control (RRC) message.

In some examples of the method, apparatus, UE, and non-transitory computer-readable medium described herein, transmitting the reporting message may include operations, features, means, or instructions for transmitting the reporting message via uplink control information.

In some examples of the method, apparatus, UE, and non-transitory computer-readable medium described herein, transmitting the reporting message may include operations, features, means, or instructions for transmitting the reporting message via one or more MAC control elements.

A method for wireless communications by a network entity is described. The method may include obtaining a reporting message including information indicative of one or more interference patterns, the one or more interference patterns associated with one or more signals that interfere with a message transmitted via a physical downlink channel and outputting a control message indicating a configuration for a set of multiple reference signals associated with estimation of an interference covariance matrix, where the configuration is based on the one or more interference patterns.

An apparatus for wireless communications at a network entity is described. The apparatus may include one or more processors and instructions stored in one or more memories and executable by the one or more processors, individually or collectively, to cause the apparatus to obtain a reporting message including information indicative of one or more interference patterns, the one or more interference patterns associated with one or more signals that interfere with a message transmitted via a physical downlink channel and output a control message indicating a configuration for a set of multiple reference signals associated with estimation of an interference covariance matrix, where the configuration is based on the one or more interference patterns.

A network entity for wireless communications is described. The network entity may include means for obtaining a reporting message including information indicative of one or more interference patterns, the one or more interference patterns associated with one or more signals that interfere with a message transmitted via a physical downlink channel and means for outputting a control message indicating a configuration for a set of multiple reference signals associated with estimation of an interference covariance matrix, where the configuration is based on the one or more interference patterns.

A non-transitory computer-readable medium storing code for wireless communications is described. The code may include instructions executable by one or more processors to obtain a reporting message including information indicative of one or more interference patterns, the one or more interference patterns associated with one or more signals that interfere with a message transmitted via a physical downlink channel and output a control message indicating a configuration for a set of multiple reference signals associated with estimation of an interference covariance matrix, where the configuration is based on the one or more interference patterns.

In some examples of the method, apparatus, network entity, and non-transitory computer-readable medium described herein, the information indicative the one or more interference patterns includes one or more time-domain averaging boundaries associated with one or more interference covariance matrix estimation computations of a UE.

In some examples of the method, apparatus, network entity, and non-transitory computer-readable medium described herein, the information indicative the one or more interference patterns includes a bitmap indicating the one or more time-domain averaging boundaries for a set of multiple symbol periods associated with the physical downlink channel.

In some examples of the method, apparatus, network entity, and non-transitory computer-readable medium described herein, obtaining the reporting message may include operations, features, means, or instructions for obtaining the reporting message in accordance with a periodicity.

Some examples of the method, apparatus, network entity, and non-transitory computer-readable medium described herein may further include operations, features, means, or instructions for outputting one or more messages that trigger a transmission of the reporting message, where the reporting message may be obtained in accordance with the one or more messages.

In some examples of the method, apparatus, network entity, and non-transitory computer-readable medium described herein, the one or more messages include downlink control information, MAC control element messages, or any combination thereof.

In some examples of the method, apparatus, network entity, and non-transitory computer-readable medium described herein, obtaining the reporting message may include operations, features, means, or instructions for obtaining the reporting message in accordance with one or more event triggers being satisfied.

Some examples of the method, apparatus, network entity, and non-transitory computer-readable medium described herein may further include operations, features, means, or instructions for outputting one or more control messages indicating a configuration of one or more interference measurement windows, where the reporting message may be based on the configuration of the one or more interference measurement windows.

In some examples of the method, apparatus, network entity, and non-transitory computer-readable medium described herein, the configuration may be for a link of a set of one or more links, the configuration including one or more time-domain locations of the set of multiple reference signals, a time density of the set of multiple reference signals, a frequency density of the set of multiple reference signals, one or more offsets associated with the set of multiple reference signals, or any combination thereof.

In some examples of the method, apparatus, network entity, and non-transitory computer-readable medium described herein, the configuration may be from a set of multiple configurations for the set of multiple reference signals.

In some examples of the method, apparatus, network entity, and non-transitory computer-readable medium described herein, the control message includes downlink control information or an RRC message.

In some examples of the method, apparatus, network entity, and non-transitory computer-readable medium described herein, obtaining the reporting message may include operations, features, means, or instructions for obtaining the reporting message via uplink control information or via one or more MAC control elements, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports interference pattern measurement and signaling in accordance with one or more aspects of the present disclosure.

FIG. 2 shows an example of a wireless communications system that supports interference pattern measurement and signaling in accordance with one or more aspects of the present disclosure.

FIG. 3 shows an example of a wireless communications system that supports interference pattern measurement and signaling in accordance with one or more aspects of the present disclosure.

FIG. 4 shows an example of a bitmap that supports interference pattern measurement and signaling in accordance with one or more aspects of the present disclosure.

FIG. 5 shows an example of a reporting timeline that supports interference pattern measurement and signaling in accordance with one or more aspects of the present disclosure.

FIG. 6 shows an example of a process flow that supports interference pattern measurement and signaling in accordance with one or more aspects of the present disclosure.

FIGS. 7 and 8 show block diagrams of devices that support interference pattern measurement and signaling in accordance with one or more aspects of the present disclosure.

FIG. 9 shows a block diagram of a communications manager that supports interference pattern measurement and signaling in accordance with one or more aspects of the present disclosure.

FIG. 10 shows a diagram of a system including a device that supports interference pattern measurement and signaling in accordance with one or more aspects of the present disclosure.

FIGS. 11 and 12 show block diagrams of devices that support interference pattern measurement and signaling in accordance with one or more aspects of the present disclosure.

FIG. 13 shows a block diagram of a communications manager that supports interference pattern measurement and signaling in accordance with one or more aspects of the present disclosure.

FIG. 14 shows a diagram of a system including a device that supports interference pattern measurement and signaling in accordance with one or more aspects of the present disclosure.

FIGS. 15 through 19 show flowcharts illustrating methods that support interference pattern measurement and signaling in accordance with one or more aspects of the present disclosure.

### DETAILED DESCRIPTION

Some wireless communication devices may be configured with time-domain resource allocations for transmissions (e.g., physical uplink shared channel (PUSCH) transmissions, physical downlink shared channel (PDSCH) transmissions) that cross one or more slot boundaries. Such configurations may be referred to as “fluid” start and length indicator value (SLIV) (fluid SLIV) designs. As a result of these configurations, and to reduce overhead of demodulation reference signal (DMRS) transmissions, one or more DMRSs may be transmitted across the resource allocation (e.g., uniformly transmitted across the resource allocation), which may result in a relatively reduced density of DMRS transmissions. A DMRS may be used to aid in signal demodulation and may be further used by a receiving device to estimate various characteristics of the channel. As an example, one or more DMRS may be used by a receiving device to identify interference (e.g., bursty interference), and the DMRS may be further used for interference covariance matrix (e.g., Rnn) estimation. The interference may be uplink interference or downlink interference (e.g., from one or more neighboring cells).

A reduction in DMRS, however, may result in a receiving device being unable to perform efficient and accurate channel estimation operations (e.g., to estimate channel interference) and interference covariance matrix estimation. To increase the effectiveness of channel estimation techniques, a wireless communication device may receive one or more interference covariance matrix estimation reference signals (e.g., interference covariance matrix estimation reference signals, Rnn estimation reference signals, data-carrying reference signals (DC-RSs)), which may be received within a time interval where DMRS is absent but there may still be a potential for interference. For example, a user equipment (UE) may receive (e.g., from a network entity) a message that configures a set of one or more covariance matrix estimation reference signals that may be included in a PUSCH transmission and/or a PDSCH transmission, where the set of one or more covariance matrix estimation reference signals may be configured to correspond to some pattern of interference (e.g., from a neighboring cell). In some cases, however, a network entity may not be aware of the interference detected by the UE, and the network entity may therefore be unable to accurately configure the one or more covariance matrix estimation reference signals in time intervals (e.g., symbols) that correspond to the interference detected by the UE.

As described herein, techniques may enable a UE to transmit signaling that is indicative of interference patterns detected by the UE, and a network entity may use such information to configure the set of one or more interference covariance matrix estimation reference signals. As an example, a UE may monitor for one or more signals that interfere with a PDSCH transmission. The UE may perform per-slot estimation of the interference from such signals, and the UE may determine an interference pattern corresponding to the interfering signals. The UE may transmit a reporting message that indicates the interference pattern (or, equivalently, Rnn time-domain averaging boundaries). In response, the network entity may configure the set of one or more interference covariance matrix estimation reference signals based on the interference pattern indicated by the UE. In some aspects, the UE may transmit the reporting message in response to network signaling, based on one or more event triggers, based on a periodicity, or any combination thereof.

Aspects of the present disclosure may be implemented to realize one or more potential advantages. For example, by signaling an indication of the interference pattern and/or Run time-domain averaging boundaries to the network, the network may be able to more efficiently and accurately configure covariance matrix estimation reference signals. Accordingly, the configuration(s) of the covariance matrix estimation reference signals may improve a receiving device's (e.g., a UE's) ability to perform channel estimation in the presence of interference. Such techniques may accordingly improve the quality of wireless communications, enabling improved reception of messages in the presence of interference.

Aspects of the disclosure are initially described in the context of wireless communications systems. Further aspects are described with reference to an interference pattern bitmap and a reporting timeline that may include one or more interference pattern measurement windows. Aspects of the disclosure are further illustrated by and described with reference to apparatus diagrams, system diagrams, and flowcharts that relate to interference pattern measurement and signaling.

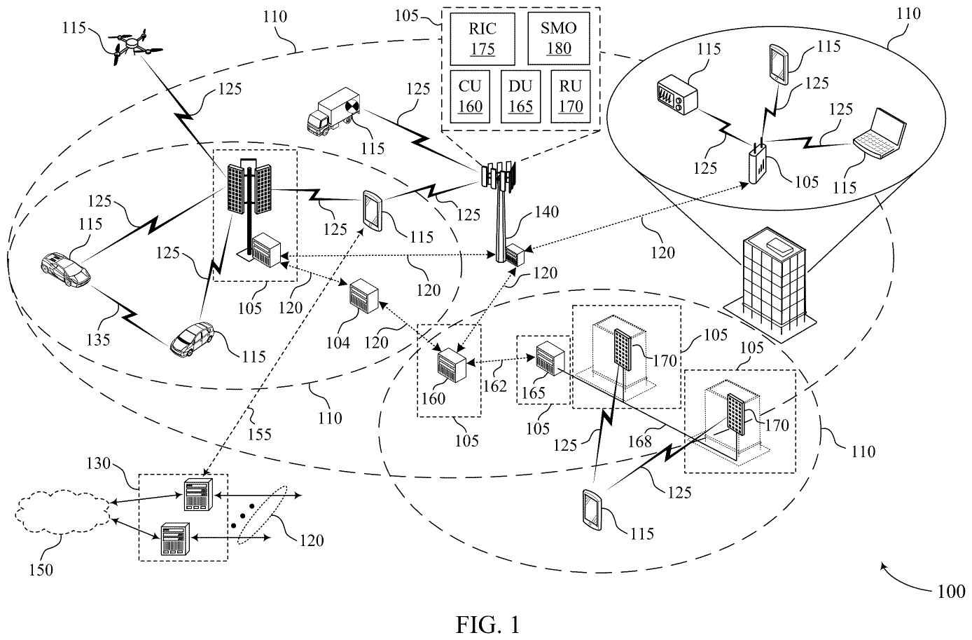

FIG. 1 shows an example of a wireless communications system 100 that supports interference pattern measurement and signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support interference pattern measurement and signaling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support signaling that indicates one or more interference patterns detected by a wireless communication device, where a network entity 105 may use the one or more interference patterns detected by the wireless communication device to configure covariance matrix estimation reference signals for covariance matrix estimation. For example, a UE 115 may detect one or more signals that interfere with a downlink transmission (e.g., a PDSCH transmission), and the UE 115 may determine an interference pattern associated with the interfering signals. In some aspects, the UE 115 may use one or more algorithms to determine the interference pattern over multiple slots. The UE 115 may transmit a reporting message that includes an indication of the interference pattern and/or one or more Rnn time-domain averaging boundaries. As an example, the UE 115 may transmit a bitmap that indicates Rnn time-domain averaging boundaries used by the UE 115 across multiple symbols. In some examples, the transmission of the reporting message may be based on received signaling (e.g., signaling received from a network entity 105), based on one or more event triggers, based on a periodicity, or any combination thereof. The UE 115 may receive, from the network entity 105, a configuration of one or more covariance matrix estimation reference signals (e.g., Rnn estimation reference signals). The configuration of the covariance matrix estimation reference signals may be based on the interference pattern indicated by the reporting message from the UE 115. In such cases, the Rnn estimation reference signals may be configured to correspond to the interference pattern (and/or Rnn time-domain averaging boundaries) identified by the UE 115, which may enable enhanced interference mitigation and improved communications between the UE 115 and the network entity 105, among other advantages.

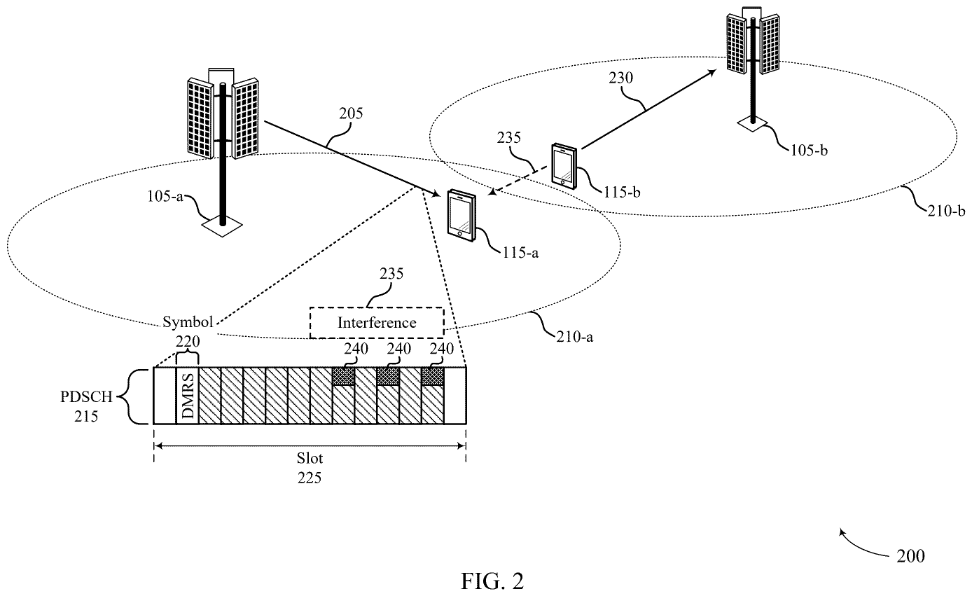

FIG. 2 shows an example of a wireless communications system 200 that supports interference pattern measurement and signaling in accordance with one or more aspects of the present disclosure. In some examples, the wireless communications system 200 may implement aspects of wireless communications system 100. For example, wireless communications system may include a network entity 105-a, a network entity 105-b, a UE 115-a, and a UE 115-b, which may be respective examples of the corresponding devices described with reference to FIG. 1. In some examples, the network entity 105-a may be associated with (e.g., may provide wireless communications for various devices within) a first cell 210-a, and the network entity 105-b may be associated with (e.g., may provide wireless communications for various devices within) a second cell 210-b. The second cell 210-b may be an example of a neighboring cell. Each cell 210 may be an example of a cell and/or associated with a coverage area 110, as described with reference to FIG. 1. The wireless communications system 200 may support techniques for configuring covariance estimation reference signals based on interference patterns indicated by a receiving device, such as a UE 115.

Some wireless communication devices, such as the UE 115-a, may be configured with time-domain resource allocations for communications (e.g., PUSCH transmissions, PDSCH transmissions) that cross one or more slot boundaries. Such configurations may be referred to as “fluid” SLIV designs. As a result of these configurations, and to reduce overhead of DMRS transmissions, one or more DMRSs may be transmitted across the resource allocation (e.g., uniformly transmitted across the resource allocation), which may result in a relatively reduced density of DMRS transmissions. A DMRS may be used to aid in signal demodulation and may be further used by a receiving device to estimate various characteristics of the channel. As an example, one or more DMRS may be used by a receiving device to identify interference (e.g., bursty interference), and the DMRS may be further used for interference covariance matrix (e.g., Rnn) estimation. The interference may be uplink interference or downlink interference (e.g., from one or more neighboring cells, such as from the cell 210-b).

The use of fluid SLIV designs and/or cross-SLIV DMRS combining techniques may result in instances of DMRS being relatively sparse across a transmission (such as in relatively low-Doppler scenarios). As such, there may be increased chances that interference may occur within one or more non-DMRS symbols (e.g., OFDM symbol periods that do not carry DMRS), which may not be captured in interference covariance matrix (e.g., Rnn) estimation performed by a receiving device. There may be cases where a DMRS transmitted in one or more initial symbol periods of a slot (e.g., front-loaded DMRS) prevents sufficient detection and/or estimation of interference (e.g., mini-slot interference, interference occurring in a duration of less than a slot) when such interference occurs relatively later in the slot (e.g., starting in relatively later symbols, at a location in time relatively farther away from the DMRS). In some examples, such as with fluid SLIV and/or cross-SLIV DMRS combining, the DMRS may be located in a relatively later portion of a slot (or not present in the slot). As such, interference occurring at a starting portion of (e.g., at the beginning of) such slots may not be accurately captured by the DMRS.

As an illustrative example, the network entity 105-a may transmit one or more messages to the UE 115-a via a downlink transmission 205. The downlink transmission 205 may be an example of a PDSCH transmission 215, which may be transmitted via resources including multiple symbols 220, and the multiple symbols 220 may be included in one or more slots 225. Further, the UE 115-b may transmit one or more messages to the network entity 105-b via an uplink transmission 230. There may be cases, however, where the uplink transmission 230 causes interference 235 to one or more messages received by the UE 115-a (e.g., messages that are part of the downlink transmission 205). For instance, one or both of UE 115-a or UE 115-b may be near a cell edge (e.g., near a boundary of the cell 210-a and/or cell 210-b), and the uplink transmission 230 by the UE 115-b may be detected by the UE 115-a as interference (e.g., when the UE 115-a is receiving the downlink transmission 205). In some cases, the uplink transmission 230 may be periodic, irregular, or may cause relatively “bursty” (e.g., occurring in one or more bursts) interference 235 that impacts one or more messages received by the UE 115-a. In some examples, the interference 235 may be caused by transmissions by one or more other wireless communication devices, and may be associated with uplink transmissions, downlink transmissions, sidelink transmissions, or any combination thereof. The interference 235 may be caused by other events or signals.

The interference 235 affecting the downlink transmission 205 may occur within (e.g., may affect) symbols 220 that are relatively offset from one or more symbols 220 carrying a DMRS. As an example, a DMRS may be associated with resources that are near the beginning of the slot 225 and the interference 235 may affect resources that are near the end of the slot 225. Such interference 235 may not be captured by the UE 115-a when performing interference covariance matrix estimation. An interference covariance matrix (e.g., a covariance matrix, Rnn) may be used to model a correlation between antenna array inputs and pulses. In some examples, the interference covariance matrix may be used to characterize undesired signals and create filters to remove such signals.

A wireless communication device (such as a UE 115 and/or network entity 105) may use one or more algorithms for interference estimation. For example, a first algorithm (e.g., received interference, Nₜ, estimation based on DMRS) may be used to determine a covariance matrix, \hat{R}_{NN}, according to the following equation:

$${\hat{R}}_{NN} = \frac{1}{N} \sum ( {Y}_{i} - {H}_{i} ) {( {Y}_{i} - {H}_{i} )}^{′}$$

where Hᵢ represents a channel matrix (e.g., vector) for the i^{th} symbol, N is a set of resource elements carrying DMRS, and Y represents interference and noise on a resource element carrying DMRS. In some examples, the first algorithm may be robust for cases where interference experienced by a receiving device is persistent (or absent), but the first algorithm may lack some effectiveness in the presence of bursty interference.

A second algorithm (e.g., combined DMRS and null tone-based received interference, Nₜ) may include the use of one or more null tones for non-DMRS symbols in combination with DMRS-based received interference detection for DMRS symbols. The second algorithm may be beneficial for capturing relatively bursty noise and may be associated with a minor increase in complexity (e.g., relative to the first algorithm). In some cases, however, the second algorithm may experience some loss in performance in cases where there is persistent interference or no interference present.

A third algorithm (e.g., an Ryy-based method) may include the estimation of a covariance matrix, Rnn, from one or more data tones in accordance with the following equations:

$${R}_{yy} = \frac{1}{N} \sum {Y}_{i} {Y}_{i}^{′} \approx \frac{1}{N} \sum {\hat{H}}_{i} \cdot {\hat{H}}_{i}^{′} + {ΔH}_{i} Δ {H}_{i}^{′} + {G}_{i} \cdot {G}_{i}^{′} + {n}_{i} \cdot {n}_{i}^{′}$$

$${\hat{R}}_{NN} = {R}_{yy} - \frac{1}{N} \sum \text{?} - {N}_{o} I$$

where i is a symbol period, G represents a composite channel, N_{O} represents a noise variance, and n represents additive noise. The third algorithm may be used to effectively capture a spatial signature, may be suitable for Rank1 interference, and may not be associated with rate loss. In some cases, the third algorithm may be associated with relatively more samples needed for interference covariance matrix estimation (e.g., Rnn estimation). Other algorithms may be used by a receiving device to detect interference and estimate channel quality.

A relative reduction in DMRS may result in a receiving device (e.g., a UE 115) being unable to perform efficient and accurate channel estimation operations (e.g., to estimate channel interference) and interference covariance matrix estimation. To increase the effectiveness of channel estimation techniques, one or more interference covariance matrix estimation reference signals 240 (e.g., Rnn estimation reference signals, DC-RSs) may be configured. For example, the one or more interference covariance matrix estimation reference signals 240 may be received within a time interval where DMRS is sparse or absent in the slot 225, and the one or more interference covariance matrix estimation reference signals 240 may be configured in resources where there may be a potential for interference (such as the interference 235). In some cases, the UE 115-a may receive (e.g., from the network entity 105-a) a message that configures a set of one or more interference covariance matrix estimation reference signals 240 that may be included in a PUSCH transmission and/or a PDSCH transmission 215. In some examples, the set of one or more interference covariance matrix estimation reference signals 240 may be configured to correspond to some pattern of interference 235 (e.g., from a neighboring cell, such as cell 210-b, or from one or more other devices). Such additional reference signals (e.g., in addition to the DMRS) may be used to assist a receiving device (e.g., a UE 115) in identifying interference, and such reference signals may be included in one or more data-carrying resources, which may provide for the efficient use of resources (e.g., as DMRS symbols may not include other data) used for wireless communications.

The network entity 105-a, however, may not be aware of the interference 235 detected by the UE 115-a, and the network entity 105-a may therefore be unable to accurately configure the one or more interference covariance matrix estimation reference signals in time intervals (e.g., symbols 220) that correspond to the interference 235 detected by the UE 115-a. For example, the network entity 105-a may be unaware of which symbols 220 of one or more slots 225 are affected by the interference 235 (e.g., corresponding to an interference pattern) identified by the UE 115-a. The network entity 105-a may be unable to accurately configure one or more interference covariance matrix estimation time-domain averaging boundaries and/or a pattern of the one or more interference covariance matrix estimation reference signals 240 corresponding to the detected interference.

As described herein, the wireless communications system 200 may support signaling (e.g., from the UE 115-a to the network entity 105-a) that is indicative of interference patterns detected by a receiving device (e.g., the UE 115-a). The network entity 105-a may use such information to configure a set of one or more interference covariance matrix estimation reference signals 240. As an example, the UE 115-a may monitor for one or more signals that interfere with the PDSCH transmission 215 (e.g., the UE 115-a may monitor for the interference 235, which may include one or more signals associated with the uplink transmission 230 or associated with one or more other transmissions). The UE 115-a may perform per-slot estimation of the interference from such signals, and the UE 115-a may determine an interference pattern corresponding to the interference 235. In some examples, the UE 115-a may determine one or more Rnn time-domain averaging boundaries corresponding to the interference 235 detected by the UE 115-a. The UE 115-a may transmit a reporting message to the network entity 105-a that indicates the interference pattern (or, equivalently, the Rnn time-domain averaging boundaries). In response, the network entity 105-a may configure the set of one or more interference covariance matrix estimation reference signals 240 based on the interference pattern indicated by the UE 115-a.

In some aspects, the reporting message indicative of the interference pattern may be periodic, triggered by the network, or event triggered, or any combination thereof. For example, the UE 115-a may transmit the reporting message indicating the interference pattern and/or Rnn time-domain averaging boundaries based on some periodicity (e.g., a preconfigured periodicity). In some examples, the UE 115-a may receive, from the network entity 105-a, one or more messages (e.g., downlink control information, MAC-CE) that trigger the transmission of the reporting message indicating the interference pattern and/or Rnn time-domain averaging boundaries, where the UE 115-a may transmit the reporting message in response to the reception of the one or more triggering messages. Additionally, or alternatively, the UE 115-a may transmit the reporting message indicating the interference pattern and/or Rnn time-domain averaging boundaries based on the occurrence of one or more events (e.g., based on monitoring the interference 235, based on an interference pattern corresponding to the interference 235).

The described techniques used for indicating one or more interference patterns and/or one or more Rnn time-domain averaging boundaries (e.g., corresponding to at least the interference 235) detected by the UE 115-a may enable the implementation of accurate Rnn time-domain averaging boundaries. For example, by signaling an indication of the interference pattern and/or Rnn time-domain averaging boundaries to the network entity 105-a, the network entity 105-a may efficiently and accurately the configure interference covariance matrix estimation reference signals 240. Accordingly, the configuration(s) of the interference covariance matrix estimation reference signals 240 may improve a receiving device's (e.g., the UE 115-a) ability to perform channel estimation in the presence of the interference 235 in accordance with the Run time-domain averaging boundaries. Such techniques may accordingly improve the quality of wireless communications, enabling improved reception of messages in the presence of interference. The receiver-based Rnn time-domain averaging boundaries identification described herein may be associated with increased accuracy (e.g., because the UE 115-a indicates the interference seen at the receiver), which may further reduce signaling overhead (e.g., compared to techniques where interference patterns are indicated between respective network entities 105).

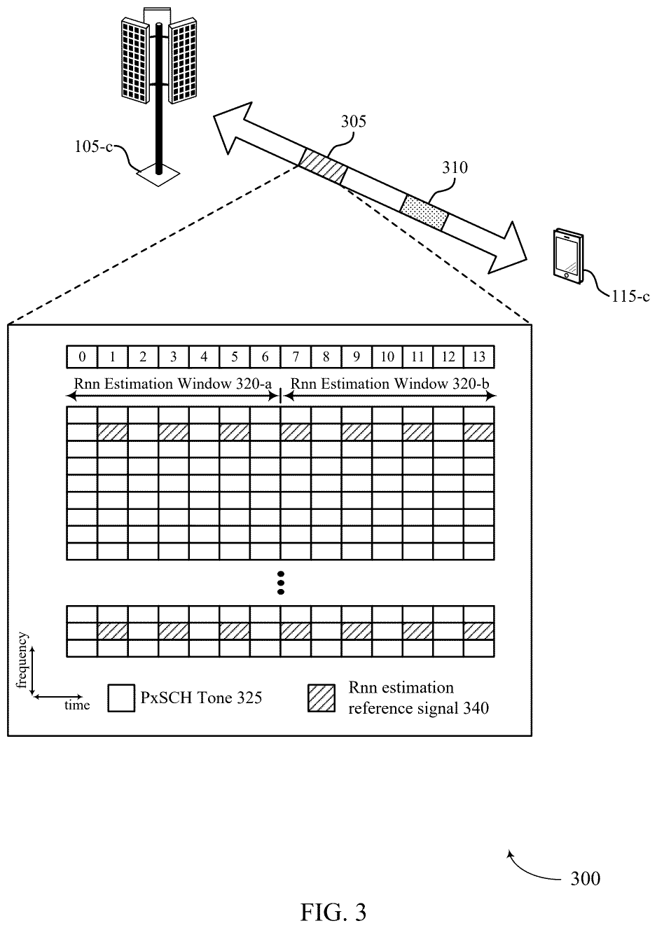

FIG. 3 shows an example of a wireless communications system 300 that supports interference pattern measurement and signaling in accordance with one or more aspects of the present disclosure. The wireless communications system 300 may include some aspects of the wireless communications system 100 and/or the wireless communications system 200. For example, the wireless communications system 300 may include a UE 115-c and a network entity 105-c, which may be respective examples of a UE 115 and a network entity 105, as described with reference to FIGS. 1 and 2. The wireless communications system 300 may support techniques for configuring interference covariance estimation reference signals based on interference patterns indicated by a receiving device, such as a UE 115.

The network entity 105-c communicate an indication of a SLIV that may indicate resource allocations that spans across one or more slot boundaries. In some examples, a SLIV that indicates a resource allocation spanning one or more slot boundaries may be referred to as a long SLIV or fluid SLIV, or some similar terminology. In some examples, a long SLIV may include or indicate a length of a resource allocation which is greater than one slot. The long SLIV design may allow some physical channel transmission 305, such as PDSCH and/or PUSCH, to support coverage extension techniques. In some examples, to reduce DMRS overhead in the wireless communications system 300, a transmitting device (e.g., the network entity 105-c, the UE 115-c) may transmit the DMRS uniformly across the allocation (e.g., across multiple slots), which may result in reduced DMRS transmissions relative to other (e.g., non-long SLIV) allocations.

A time span that includes a group of DMRS symbols may be referred to a channel estimation window. A size of the channel estimation window to allow for DMRS bundling may be dependent on a UE buffer constraint. For example, for downlink, a combinable DMRS resource in adjacent transmission time intervals or slots may be indicated to the UE 115-c, and the UE 115-c may perform cross SLIV combining. In some cases, such as in low-doppler scenarios, when cross-slot DMRS pattern is used, a slot may not include a DMRS. In such cases with relatively sparser DMRS symbols, chances of interference on non-DMRS symbols may be relatively increased, and such interference may not be captured during interference covariance matrix estimation procedures.

The reduction in DMRS transmissions may result in receiver devices (e.g., the UE 115-c, the network entity 105-c) being unable to perform efficient and accurate channel estimation operations to estimate channel interference. Null resource elements may be introduced into one or more estimation windows (e.g., Rnn estimation window 320-a, Rnn estimation window 320-b, each of which may be an example of an Rnn estimation window) of a physical channel transmission 305 (e.g., a PUSCH, a PDSCH) to avoid or limit channel collisions. In some cases, some resource may be used for transmission of interference covariance matrix estimation reference signals 340 (e.g., Rnn estimation reference signals).

To increase effectiveness of channel estimation techniques used in determining channel interference within the wireless communications system 300 and to reduce throughput impact, a wireless communications device (e.g., the UE 115-c, the network entity 105-c) may communicate interference covariance matrix estimation reference signals 340 in accordance with a configuration. In such cases, the interference covariance matrix estimation reference signals 340 may be used for interference covariance matrix estimation operations and may carry shared channel data. For example, the UE 115-c may receive (e.g., from the network entity 105-c) control signaling including a configuration message that may configure the interference covariance matrix estimation reference signals 340 for inclusion in physical channel transmission 305 (e.g., a PUSCH and/or PDSCH (which may be referred to as PxSCH)). The control signaling (e.g., the configuration message thereof) may indicate that the interference covariance matrix estimation reference signals 340 may be communicated via a subset of resource elements of a shared data channel, and that the interference covariance matrix estimation reference signals 340 may be configured to encode data allocated to the shared channel. In some cases, the control signaling may specify an MCS, a quantity of layers, a subset of ports, a pattern of resource elements, among other parameters, to use in communicating the interference covariance matrix estimation reference signals 340.

In response to receiving the control signaling, in an uplink scenario, the UE 115-c may encode a PUSCH (e.g., one or more interference covariance matrix estimation reference signals 340 and the PUSCH data) in accordance with the various parameters, and the network entity 105-c may decode the PUSCH based on the various parameters and determine the covariance matrix. In a downlink scenario, the network entity 105-c may encode a PDSCH (e.g., one or more interference covariance matrix estimation reference signals 340 and the PDSCH data) in accordance with the various parameters, and the UE 115-c may decode the PDSCH in accordance with the various parameters and determine the covariance matrix. For example, the UE 115-b may receive the control signaling and may determine a covariance matrix, \hat{R}_{NN}.

In some examples, the interference covariance matrix estimation reference signals 340 (e.g., Rnn estimation reference signals) may be configured per precoding resource block group (PRG), which may be based on one or more frequency-domain windows and based on time-domain averaging start and end boundaries. For example, the interference covariance matrix estimation reference signals 340 may be configured for each of one or more time-domain windows (e.g., time segment) and for each frequency domain window, which may allow the UE 115-c to measure interference (e.g., bursty interference, interference from one or more neighboring cells). In such cases, within a time segment of a resource allocation (e.g., according to an SLIV) where there is an absence of a DMRS symbol and a potential for interference, one or more interference covariance matrix estimation reference signals 340 (e.g., sparse Rnn estimation reference signals) may be included in a transmission.

Parameters associated with the configuration of the interference covariance matrix estimation reference signals 340 may correspond to one or more frequency-domain patterns of the interference covariance matrix estimation reference signals 340. As an example, the frequency domain pattern may indicate a transmission of one interference covariance matrix estimation reference signal 340 resource element for some quantity of tones 325 (e.g., one Rnn estimation reference signal every Y tones 325) per PRG. In some cases, if per PRG precoding is applied, an interference spatial signature may vary from PRG to PRG, and frequency-domain Rnn averaging may be used for each PRG. A tone offset may be configured with respect to some tone (e.g., Point A), which may affect the likelihood of one or more Rnn estimation reference signals colliding with a target cell's Rnn estimation reference signal. In some examples, quadrature phase shift keying (QPSK) interference may be associated with relatively fewer Rnn estimation reference signals than data.

Additionally, or alternatively, the parameters associated with the configuration of the interference covariance matrix estimation reference signals 340 may correspond to one or more time-domain patterns of the interference covariance matrix estimation reference signals 340. For example, when the network entity 105-c has information about an interference pattern associated with one or more the neighboring cells, one or more Rnn estimation time-domain boundaries may be used for estimation of interference covariance matrix estimation procedures. In one example, a smallest scheduling granularity in the time domain may be half of a slot, and the respective Rnn estimation time-domain averaging boundaries (e.g., corresponding to Rnn estimation window 320-a and Rnn estimation window 320-b) may correspond to symbols (0,6) and (7,13). Some other quantity of Rnn estimation windows 320 may be possible (such as one Rnn estimation window, three Rnn estimation windows, among other examples).

The network entity 105-c may configure a set of one or more interference covariance matrix estimation reference signals 340 (Rnn estimation reference signals) for each Rnn estimation time-domain averaging boundary. In some examples, the configuration of the interference covariance matrix estimation reference signals 340 may skip one or more DMRS symbols (e.g., symbols that carry DMRS), and the interference covariance matrix estimation reference signals 340 may be configured to include one interference covariance matrix estimation reference signal symbol for some quantity of symbols (e.g., one Rnn estimation reference signal symbol every X symbols) within each Rnn estimation window 320. In some cases, some Rnn estimation windows that include DMRS may not be configured with the interference covariance estimation reference signals, as DMRS-based Rnn estimation may be used for such windows instead. In some aspects, within each Rnn estimation window 320 and one PRG, a time/frequency density may be chosen for the corresponding configuration such that a quantity (e.g., a total quantity) of interference covariance matrix estimation reference signal resource elements is greater than or equal to a threshold quantity (e.g., to ensure improved interference covariance matrix estimation quality). In some aspects, for a given link, a receive beam used for receiving data may be utilized for computing the interference covariance matrix (e.g., Rnn). In cases where the receiving device is unable to detect the interference, or detects relatively weak interference, via that receive beam, the one or more interference covariance matrix estimation reference signals may not be configured.

A wireless communication device (such as the UE 115-c) may perform one or more coarse interference identification procedures (such as a cascaded binary iterative detection (CBID) algorithm), which may be based on per-symbol Ryy techniques. Using such techniques, the wireless communication device may identity which symbols are affected by interference symbols. In such cases, the UE 115-c may compute a per-symbol coarse Rnn based on the Ryy techniques (e.g., using the third algorithm described with reference to FIG. 2), and the UE 115-c may determine whether the interference in contiguous symbols (e.g., in two contiguous symbols) corresponds to the same interference (e.g., associated with the same cross-link interference (CLI), having a same spatial signature). In cases where the receiving device performs the coarse interference identification procedures (e.g., the CBID algorithm) and coarse per-symbol Rnn for a quantity of slots, the receiving device may identify a threshold (e.g., minimum) granularity of the interference. As an example, the UE 115-c may identify that interference affects a four-symbol mini-slot, and the UE 115-c may determine corresponding Rnn estimation time-domain averaging boundaries. In such cases, it may be beneficial to convey the information regarding the interference and/or Rnn estimation time-domain averaging boundaries to the network to assist the network entity 105-c in configuring one or more patterns for the interference covariance matrix estimation reference signals 340. In some aspects, a pattern for the interference covariance matrix estimation reference signals 340 (e.g., an Rnn estimation reference signal pattern) may refer to a time-domain pattern, a frequency-pattern, or any combination thereof. In some examples, the pattern for the interference covariance matrix estimation reference signals 340 may correspond to one or more parameters being configured for one or more sets of interference covariance matrix estimation reference signals 340 for transmission via a physical channel transmission 305.

In some cases (such as for uplink interference), the network entity 105-c may determine a corresponding interference pattern by running an interference detection algorithm (such as the CBID algorithm or/and coarse Rnn estimation) across multiple slots, and the network entity 105-c may adapt (e.g., configure) the pattern of the interference covariance estimation reference signals 340. The network entity 105-c may indicate the adapted configuration of the interference covariance estimation reference signals 340, for example, via layer 1 (L1) signaling to the UE 115-c.

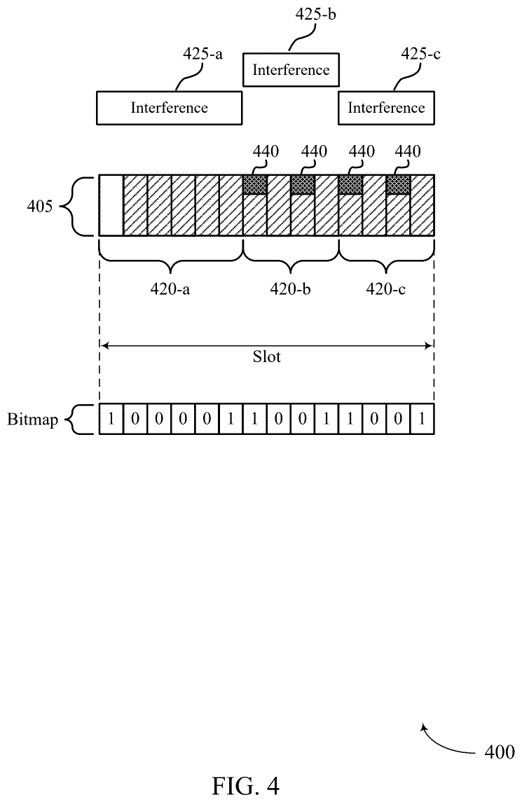

For downlink interference, the UE 115-c may detect one or more interference patterns over multiple slots, and the UE 115-c may transmit an indication of the interference patterns (or equivalently, the Rnn time-domain averaging boundaries) to the network entity 105-c. That is, the UE 115-c may transmit a reporting message 310 that indicates the receiver-observed interference patterns or Rnn time-domain averaging boundaries to the network entity 105-c. In some aspects, the reporting message 310 may be transmitted via L1 or layer 2 (L2) signaling. In some examples, the reporting message 310 and the information indicative of the interference pattern and/or Rnn time-domain averaging boundaries may be transmitted via uplink control information (UCI) and/or via one or more channel state information (CSI) reports, among other examples. Additionally, or alternatively, the reporting message 310 may be transmitted via a MAC-CE or another type of uplink signaling. In some examples, as described with reference to FIG. 4, the information indicative of the interference pattern and/or Rnn time-domain averaging boundaries may be included in the reporting message 310 as a bitmap (e.g., a per-slot bitmap).

In some examples, interference patterns from one or more other cells may vary from time to time based on communications traffic and scheduling of various wireless communication devices. As such, it may be beneficial for the network entity 105-c may to obtain the most up to date interference pattern information from the UE 115-c. Therefore, the UE 115-c may transmit the reporting message 310 to indicate the interference pattern and/or the Rnn time-domain averaging boundaries based on a periodicity, after being triggered by the network, based on one or more event triggers, or any combination thereof. As an example, the UE 115-c may transmit the reporting message 310 periodically, which may be used to regularly update the network entity 105-c with up-to-date information regarding the interference pattern(s) detected by the UE 115-c. In such examples, the reporting message may be transmitted in accordance with some preconfigured periodicity or configured periodicity (e.g., configured via one or more control messages).

Additionally, or alternatively, the reporting message 310 including the information indicative of the interference pattern and/or Rnn time-domain averaging boundaries may be transmitted based on the network entity 105-c triggering the transmission of the reporting message 310, for example, via downlink signaling. For instance, the network entity 105-c may transmit DCI and/or a MAC-CE that triggers the transmission of the reporting message 310. In such cases, the network entity 105-c may determine when the UE 115-c provides information (and/or updated information) regarding the interference pattern(s) and Rnn time-domain averaging boundaries, which may enable dynamic configuration of the Rnn estimation reference signals.

Additionally, or alternatively, transmission of the reporting message 310 may be event triggered. As an example, the UE 115-c may monitor (e.g., continually monitor) the interference pattern detected by the UE 115-c. When there is a change in the interference pattern, the UE 115-c may transmit a reporting message 310 indicating a change or update to the interference pattern and/or Rnn time-domain averaging boundaries. In such cases, the reporting message 310 may be transmitted to the network entity 105-c via a MAC-CE, where some MAC-CE format and header may be used for such reporting.

In some cases (e.g., for uplink transmissions), different links may be associated with one or more different analog or digital receive beams and the corresponding interference detected by the receiving device may be different. In such cases, it may be beneficial to use different Rnn time-domain averaging boundaries for communications received on such links. In such cases, a receiving device (e.g., the network entity 105-c) may use different Rnn time-domain averaging boundaries (e.g., corresponding to respective interference patterns) per link. Similarly, for downlink transmissions to one or more different UEs 115, due to different receive beams and locations associated with each UE 115, interference patterns detected by each UE 115 may also be different. In such cases, the interference pattern and/or Rnn time-domain averaging boundaries may be reported per link, and the network entity 105-c may configure one or more per-link patterns of the Rnn estimation reference signals. That is, the configuration of the interference covariance matrix estimation reference signals (e.g., the Rnn estimation reference signals), which may include one or more time domain symbol locations, a time/frequency density and offsets, or any combination thereof, may be configured and adapted for each link of a set of one or more links. In such cases, the network entity 105-c may preconfigure multiple Rnn estimation reference signal patterns, for example, via RRC signaling. In such cases, based on the interference pattern and/or Rnn time-domain averaging boundaries indicated by the reporting message 310 (e.g., transmitted via UCI and/or MAC-CE), the network entity 105-c may select one pattern from the multiple Rnn estimation reference signal patterns, for example, via DCI, via a MAC-CE, via RRC signaling (e.g., an RRC reconfiguration message), or any combination thereof.

FIG. 4 shows an example of a bitmap 400 that supports interference pattern measurement and signaling in accordance with one or more aspects of the present disclosure. In some examples, the bitmap 400 may implement or may be implemented by aspects of wireless communications system 100, wireless communications system 200, and/or wireless communications system 300. For example, the bitmap 400 may be an example of a reporting message transmitted by a wireless communication device (such as a UE 115, as described with reference to FIGS. 1, 2, and 3), where the reporting message includes information indicative of one or more interference patterns and/or Rnn time-domain averaging boundaries.

As described herein a receiving device (e.g., a UE 115) may detect one or more signals that interfere with a physical channel transmission 405 (e.g., a PDSCH transmission), and the receiving device may perform one or more interference covariance matrix estimation procedures. Based on the one or more interference covariance matrix estimation procedures, the receiving device may determine one or more interference patterns that correspond to the interfering signals. Additionally, or alternatively, the receiving device may determine one or more Rnn time-domain averaging boundaries that correspond to respective Rnn estimation windows 420. As an example, a first set of one or more signals may be associated with first interference 425-a (e.g., affecting and/or received within a portion of the physical channel transmission 405), a second set of one or more signals may be associated with second interference 425-b (e.g., affecting and/or received within a portion of the physical channel transmission 405), and a third set of one or more signals may be associated with third interference 425-c (e.g., affecting and/or received within a portion of the physical channel transmission 405). In such cases, a first Rnn estimation window 420-a may correspond to the first interference 425-a, a second Rnn estimation window 420-b may correspond to the second interference 425-b, and a third Rnn estimation window 420-c may correspond to the third interference 425-c. As described herein, any quantity of Rnn estimation windows 420 may be possible, and the examples described herein are provided for illustrative purposes.

The receiving device may transmit a reporting message that is indicative of an interference pattern (e.g., a pattern including the first interference 425-a, the second interference 425-b, the third interference 425-c, or any combination thereof). For example, the reporting message may explicitly indicate the detected interference pattern. Additionally, or alternatively, the reporting message may indicate one or more Rnn time-domain averaging boundaries, for example, that correspond to each Rnn estimation window 420.

As an example, the reported Rnn time-domain averaging boundary/boundaries may be reported as per-slot bitmap, where the bitmap may correspond to a symbol bitmap with some value (e.g., ‘1’ or ‘0’) one to indicate a respective boundary of a corresponding Rnn estimation window 420. For instance, a value of ‘1’ in the bitmap may indicate either a starting symbol or an ending symbol of a corresponding Rnn estimation window, which may indicate respective Rnn time-domain averaging boundaries used by the wireless communication device (e.g., when performing per-symbol Rnn estimation).

Based on the information indicative of the interference pattern and/or Rnn time-domain averaging boundaries, a network entity (e.g., a network entity 105, as described with reference to FIGS. 1, 2, and 3) may use the information to configure one or more patterns of Rnn estimation reference signals 440 (e.g., including time-domain patterns, frequency-domain patterns, or both) to ensure that a receiving device has sufficient Rnn estimation reference signals 440 in each Rnn estimation window 420. As an example, one or more Rnn estimation reference signals 440 may be configured to correspond to the second Rnn estimation window 420-b, and one or more Rnn estimation reference signals 440 may be configured to correspond to the third Rnn estimation window 420-c. In some cases, the network entity may not configure any Rnn estimation reference signals 440 within an Rnn estimation window 420 that includes DMRS. Thus, the network entity may efficiently and accurately configure the Rnn estimation reference signals 440 using the information indicative of the interference patten and/or the Rnn time-domain averaging boundaries.

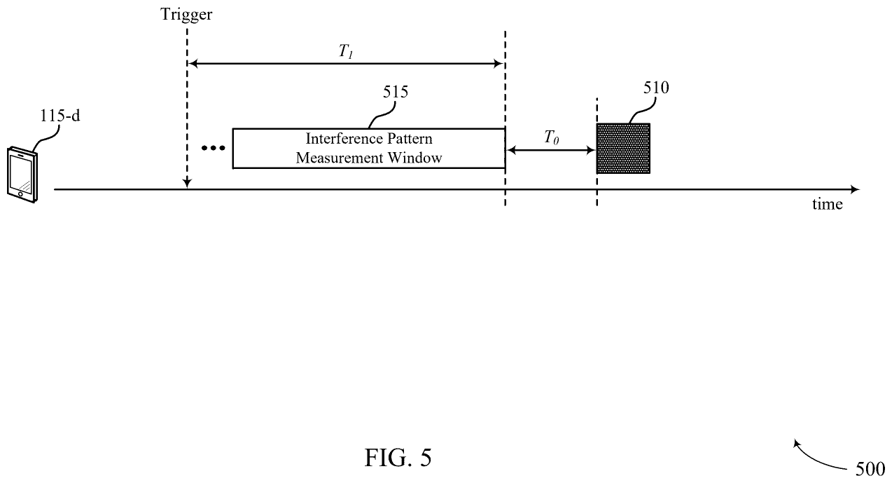

FIG. 5 shows an example of a reporting timeline 500 that supports interference pattern measurement and signaling in accordance with one or more aspects of the present disclosure. In some examples, the interference patten measurement window may implement or may be implemented by aspects of wireless communications system 100, wireless communications system 200, or wireless communications system 300, or any combination thereof. For example, the reporting timeline 500 may support the detection of one or more interference patterns, which may enable a wireless communication device (such as a UE 115, as described with reference to FIGS. 1, 2, 3, and 4) to report information that is indicative of the one or more interference patterns.

As shown in the reporting timeline 500, a UE 115-d may transmit a reporting message 510, which may include information indicative one or more interference patterns and/or one or more Rnn time-domain averaging boundaries. In such cases, the UE may monitors for interference (e.g., continuously monitor for the interference) prior to transmission of the reporting message 510. In some aspects, to ensure that a quality of interference pattern measurements is relatively high (which may correspond to the UE 115-d measuring for a long enough duration before transmitting the reporting message 510), one or more interference pattern measurement windows 515 may be configured or pre-configured. As an example, the UE 115-d may monitor for one or more interference patterns within a preconfigured interference pattern measurement window 515. In such cases, a duration of the interference pattern measurement window 515 and/or a time offset (e.g., To) associated with the interference pattern measurement window 515 may be configured (e.g., via control signaling) or pre-configured.

In some examples, such as when the reporting message 510 is transmitted periodically, the interference pattern measurement window 515 may end based on the time offset (e.g., the interference pattern measurement window 515 may end T₀ before the reporting message 510 is transmitted). Additionally, or alternatively, the interference pattern measurement window 515 may end some time offset (e.g., T₁) after a trigger message is received from the network or a time offset (e.g., T₀) before the reporting message 510 is transmitted.

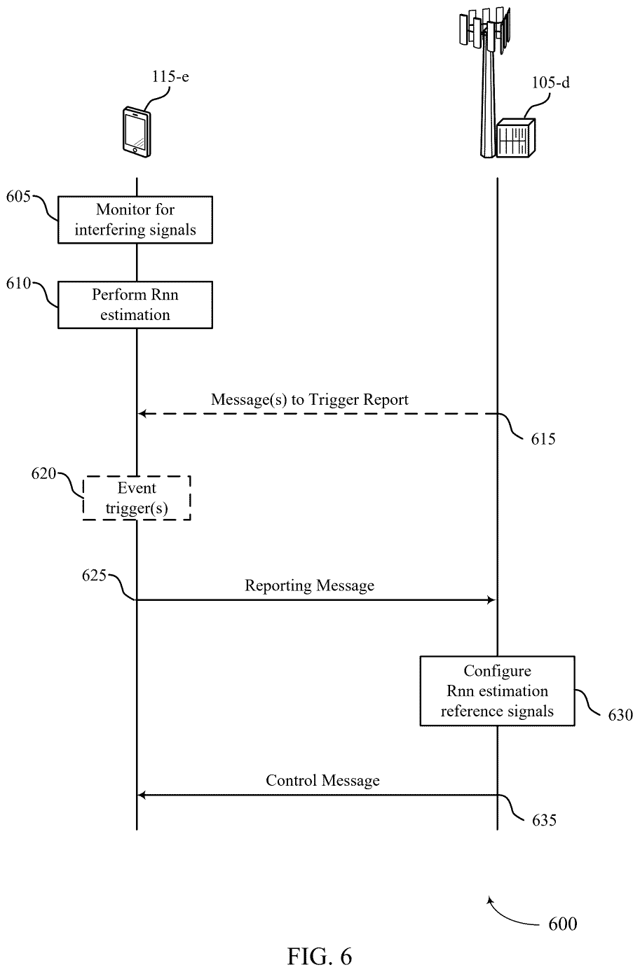

FIG. 6 shows an example of a process flow 600 that supports interference pattern measurement and signaling in accordance with one or more aspects of the present disclosure. In some cases, the process flow 600 may implement or be implemented by aspects of the wireless communications system 100, the wireless communications system 200, the wireless communications system 300, the bitmap 400, the reporting timeline 500, or any combination thereof. For example, the process flow 600 may include one or more UEs 115 (e.g., a UE 115-e) and one or more network entities 105 (e.g., a network entity 105-d), which may be examples of the corresponding devices as described herein. In the following description of the process flow 600, the operations between the UE 115-e and the network entity 105-d may be communicated in a different order than the example order shown, or the operations performed by the UE 115-e and the network entity 105-d may be performed in different orders or at different times. Some operations may also be omitted from the process flow 600, and other operations may be added to the process flow 600.

At 605, the UE 115-e may monitor for one or more signals that interfere with a message received via a physical downlink channel (e.g., a PDSCH). In some examples, the UE 115-e may monitor (e.g., continuously monitor) for interfering signals in accordance with one or more measurement windows, such as an interference pattern measurement window. In such cases, the interference pattern measurement window may be configured such that the UE 115-e detects enough samples to identify one or more interference patterns based on the one or more signals that interfere with the message. For example, the interference pattern measurement window may span at least some duration before a reporting message is transmitted by the UE 115-e.

At 610, the UE 115-e may perform per-symbol interference covariance matrix estimation computations for the physical downlink channel based on the one or more signals. For example, for one or more symbol periods of the physical downlink channel, the UE 115-e may perform Rnn estimation, which may be based on one or more Rnn estimation windows corresponding to the physical downlink channel. In some examples, one or more interference patterns across multiple symbol periods of the physical downlink channel may be identified based on the one or more interference covariance matrix estimation computations for the one or more signals. That is, the UE 115-e may identify one or more interference patterns based on detecting interference. In some cases, the one or more interference patterns may correspond to relatively bursty interference, for example, from another, neighboring cell.

At 615, the network entity 105-d may output, and the UE 115-e may receive one or more messages that trigger a transmission of a reporting message that information indicative of the one or more interference patterns (or equivalently, one or more Rnn time-domain averaging boundaries). In such cases, the network entity 105-d may trigger the reporting message to acquire information regarding the one or more interference patterns so that a configuration of one or more interference covariance matrix estimation reference signals (e.g., Rnn estimation reference signals) may be generated.

Additionally, or alternatively, at 620 the UE 115-e may identify one or more event triggers for transmitting the reporting message including the information indicative of the one or more interference patterns (and/or the Rnn time-domain averaging boundaries). In some aspects, the one or more event triggers may be based on monitoring for the one or more interfering signals, where one or more events associated with the monitoring and/or detected interference (e.g., interference patten(s)) may trigger the transmission of the reporting message.

At 625, the UE 115-e may transmit, and the network entity 105-d may obtain, the reporting message including the information indicative of the one or more interference patterns and/or the one or more Rnn time-domain averaging windows. In some aspects, the reporting message may be transmitted in accordance with a periodicity. Additionally, or alternatively, the UE 115-e may transmit the reporting message in response to the one or more messages that trigger the transmission of the reporting message (e.g., received at 615). In some examples, the UE 115-e may transmit the reporting message in response to the one or more event triggers that trigger the transmission of the reporting message (e.g., at 620).

At 630, the network entity 105-d may configure a set of one or more reference signals associated with estimation of an interference covariance matrix (e.g., interference covariance matrix estimation reference signals, Rnn estimation reference signals) based on the information indicative of one or more interference patterns and/or the one or more Rnn time-domain averaging boundaries. For example, the network entity 105-d may configure one or more patterns (e.g., frequency-domain patterns, time-domain patterns, or both) for each of a set of Rnn time-domain averaging boundaries indicated by the UE 115-e.

At 635, the network entity 105-d may output, and the UE 115-e may receive, a control message that indicates the configuration for the reference signals associated with estimation of the interference covariance matrix.

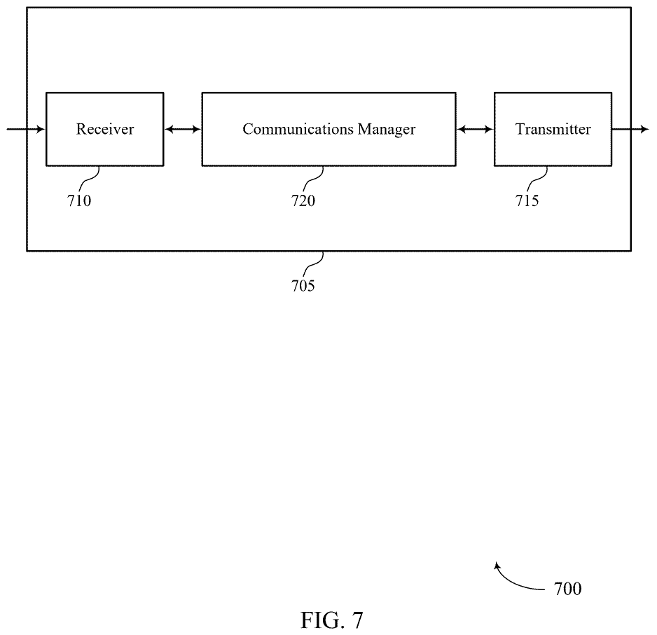

FIG. 7 shows a block diagram 700 of a device 705 that supports interference pattern measurement and signaling in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to interference pattern measurement and signaling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to interference pattern measurement and signaling). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of interference pattern measurement and signaling as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for detecting one or more signals that interfere with a message received via a physical downlink channel. The communications manager 720 is capable of, configured to, or operable to support a means for performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The communications manager 720 is capable of, configured to, or operable to support a means for transmitting, to a network entity, a reporting message including information indicative of the one or more interference patterns.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources. For example, the device 705 may support techniques for reporting information indicative of an interference pattern and/or Rnn time-domain averaging boundaries, which may enable the efficient and accurate configuration of Rnn estimation reference signals for interference detection and mitigation. Such configurations may enable the device 705 to efficiently detect interfering signals and perform channel estimation.

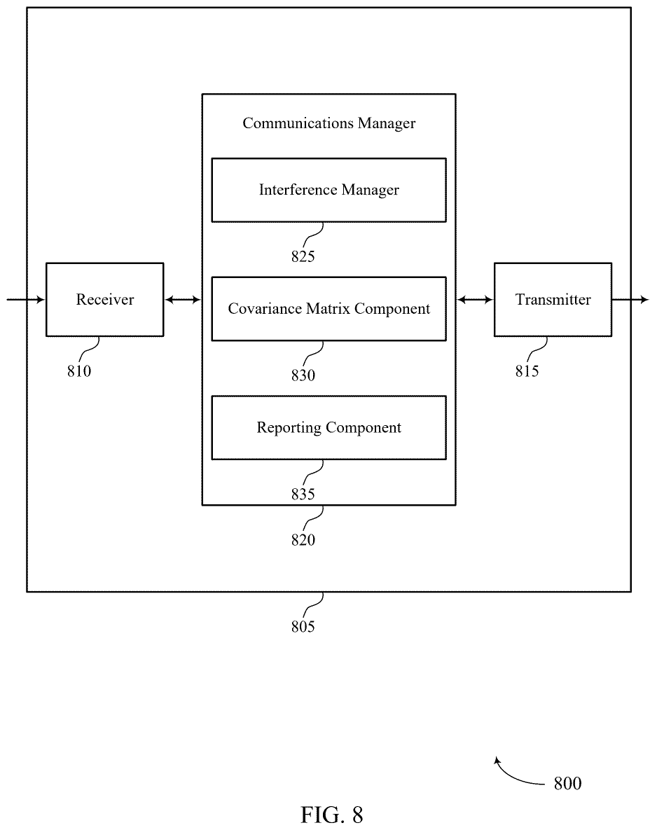

FIG. 8 shows a block diagram 800 of a device 805 that supports interference pattern measurement and signaling in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to interference pattern measurement and signaling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to interference pattern measurement and signaling). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of interference pattern measurement and signaling as described herein. For example, the communications manager 820 may include an interference manager 825, a covariance matrix component 830, a reporting component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The interference manager 825 is capable of, configured to, or operable to support a means for detecting one or more signals that interfere with a message received via a physical downlink channel. The covariance matrix component 830 is capable of, configured to, or operable to support a means for performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The reporting component 835 is capable of, configured to, or operable to support a means for transmitting, to a network entity, a reporting message including information indicative of the one or more interference patterns.

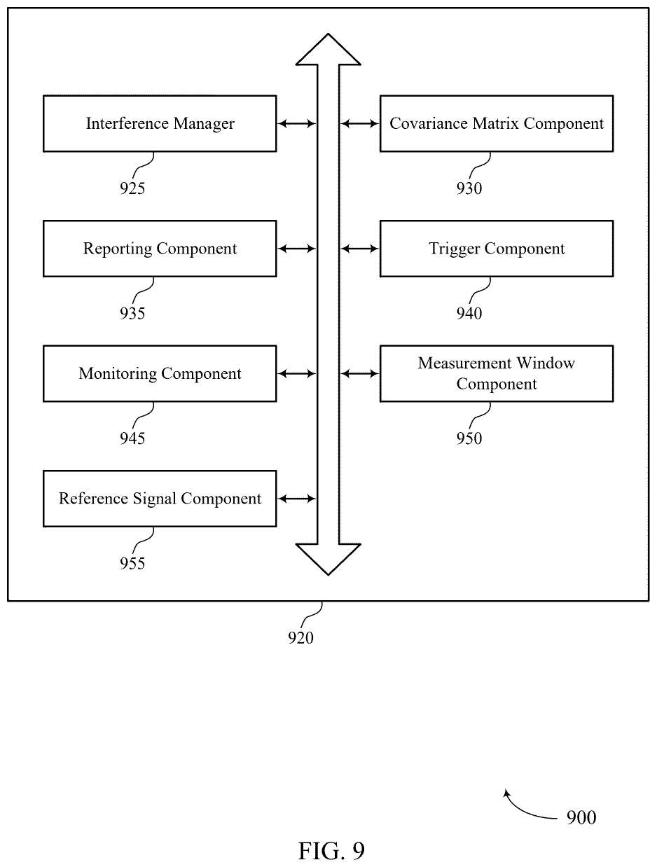

FIG. 9 shows a block diagram 900 of a communications manager 920 that supports interference pattern measurement and signaling in accordance with one or more aspects of the present disclosure. The communications manager 920 may be an example of aspects of a communications manager 720, a communications manager 820, or both, as described herein. The communications manager 920, or various components thereof, may be an example of means for performing various aspects of interference pattern measurement and signaling as described herein. For example, the communications manager 920 may include an interference manager 925, a covariance matrix component 930, a reporting component 935, a trigger component 940, a monitoring component 945, a measurement window component 950, a reference signal component 955, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The interference manager 925 is capable of, configured to, or operable to support a means for detecting one or more signals that interfere with a message received via a physical downlink channel. The covariance matrix component 930 is capable of, configured to, or operable to support a means for performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The reporting component 935 is capable of, configured to, or operable to support a means for transmitting, to a network entity, a reporting message including information indicative of the one or more interference patterns.

In some examples, the information indicative of the one or more interference patterns includes one or more time-domain averaging boundaries associated with the one or more interference covariance matrix estimation computations. In some examples, the information indicative of the one or more interference patterns includes a bitmap indicating the one or more time-domain averaging boundaries for the set of multiple symbol periods.

In some examples, to support transmitting the reporting message, the reporting component 935 is capable of, configured to, or operable to support a means for transmitting the reporting message in accordance with a periodicity.

In some examples, the trigger component 940 is capable of, configured to, or operable to support a means for receiving, from the network entity, one or more messages that trigger a transmission of the reporting message, where the reporting message is transmitted in accordance with the one or more messages. In some examples, the one or more messages include downlink control information, medium access control (MAC) control element messages, or any combination thereof.

In some examples, to support transmitting the reporting message, the reporting component 935 is capable of, configured to, or operable to support a means for transmitting the reporting message in accordance with one or more event triggers being satisfied, where the one or more event triggers are based on monitoring the one or more interference patterns.

In some examples, the monitoring component 945 is capable of, configured to, or operable to support a means for monitoring for the one or more signals during one or more interference measurement windows, where the one or more signals are detected in accordance with the monitoring.

In some examples, the measurement window component 950 is capable of, configured to, or operable to support a means for receiving, from the network entity, one or more control messages indicating a configuration of the one or more interference measurement windows, where the monitoring is based on the configuration.

In some examples, the measurement window component 950 is capable of, configured to, or operable to support a means for monitoring for the one or more signals during an interference measurement window, where the one or more signals are detected in accordance with the monitoring, and where the interference measurement window ends a first time offset before transmitting the reporting message. In some examples, a beginning of the interference measurement window starts a second time offset after one or more event triggers are satisfied.

In some examples, the reference signal component 955 is capable of, configured to, or operable to support a means for receiving, from the network entity, a control message indicating a configuration for a set of multiple reference signals associated with estimation of an interference covariance matrix, where the configuration is based on the one or more interference patterns.

In some examples, the configuration is for a link of a set of one or more links, the configuration including one or more time-domain locations of the set of multiple reference signals, a time density of the set of multiple reference signals, a frequency density of the set of multiple reference signals, one or more offsets associated with the set of multiple reference signals, or any combination thereof. In some examples, the configuration is from a set of multiple configurations for the set of multiple reference signals. In some examples, the control message includes downlink control information or an RRC message.

In some examples, to support transmitting the reporting message, the reporting component 935 is capable of, configured to, or operable to support a means for transmitting the reporting message via uplink control information.

In some examples, to support transmitting the reporting message, the reporting component 935 is capable of, configured to, or operable to support a means for transmitting the reporting message via one or more medium access control (MAC) control elements.

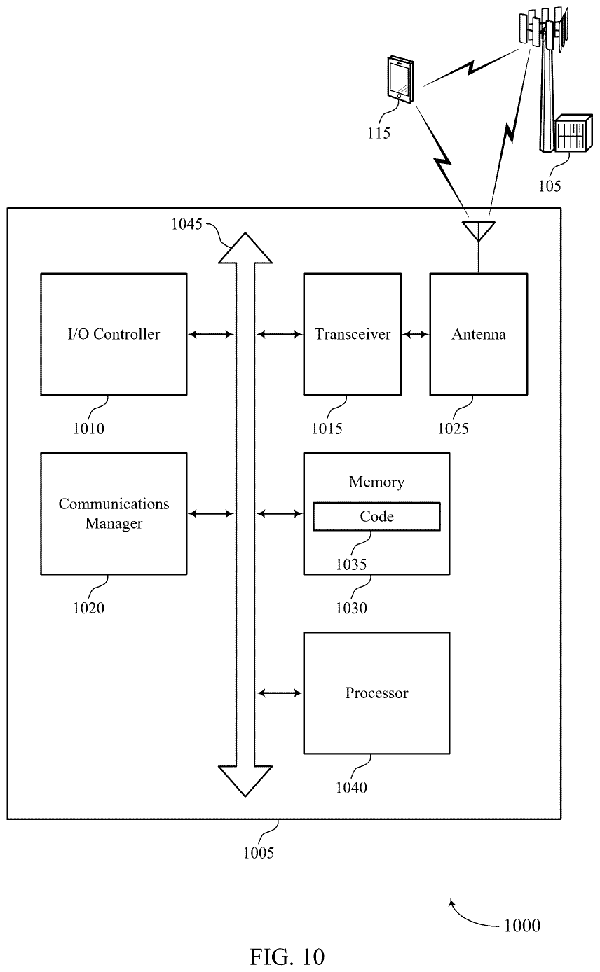

FIG. 10 shows a diagram of a system 1000 including a device 1005 that supports interference pattern measurement and signaling in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting interference pattern measurement and signaling). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for detecting one or more signals that interfere with a message received via a physical downlink channel. The communications manager 1020 is capable of, configured to, or operable to support a means for performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The communications manager 1020 is capable of, configured to, or operable to support a means for transmitting, to a network entity, a reporting message including information indicative of the one or more interference patterns.

By including or configuring the communications manager 1020 in accordance with examples as described herein, the device 1005 may support techniques for improved communication reliability, reduced latency, improved user experience related to improved reliability, more efficient utilization of communication resources, and improved coordination between devices, among other examples. In particular, configurations of Rnn estimation reference signals based on information reported to the network may be associated with improved accuracy (e.g., Rnn estimation reference signals may be configured in symbol period affected by interference, and not other symbol periods), which may provide for improved channel estimation procedures, thereby leading to improved communication and user experience.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of interference pattern measurement and signaling as described herein, or the at least one processor 1040 and the at least one memory 1030 may be otherwise configured to, individually or collectively, perform or support such operations.

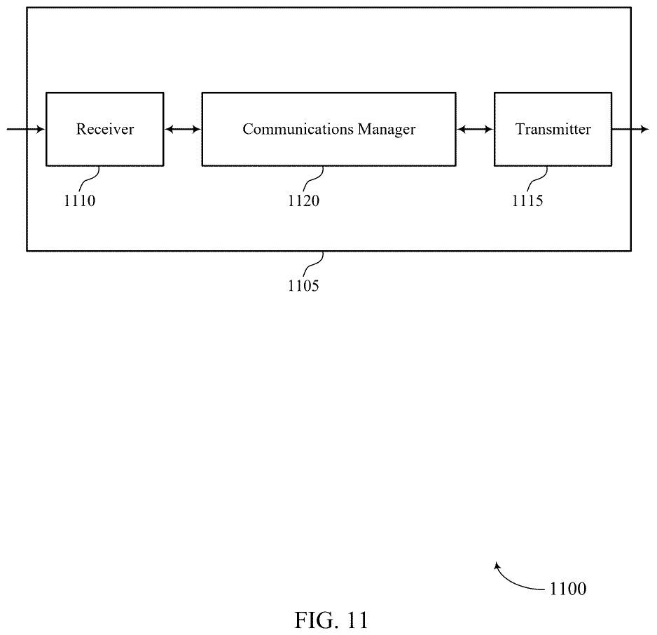

FIG. 11 shows a block diagram 1100 of a device 1105 that supports interference pattern measurement and signaling in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of interference pattern measurement and signaling as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for obtaining a reporting message including information indicative of one or more interference patterns, the one or more interference patterns associated with one or more signals that interfere with a message transmitted via a physical downlink channel. The communications manager 1120 is capable of, configured to, or operable to support a means for outputting a control message indicating a configuration for a set of multiple reference signals associated with estimation of an interference covariance matrix, where the configuration is based on the one or more interference patterns.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources. For example, the device 1105 may support techniques for receiving information indicative of an interference pattern and/or Rnn time-domain averaging boundaries determined by another device, which may enable the efficient and accurate configuration of Rnn estimation reference signals for interference detection and mitigation. As such, the device 1105 may reduce processing times and improve power consumption when configuring Rnn estimation reference signals based on the reported information.

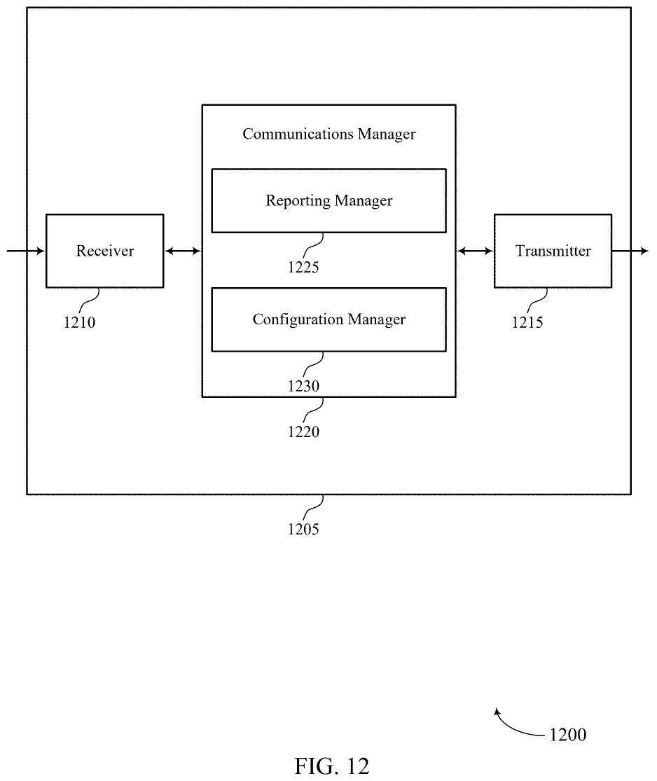

FIG. 12 shows a block diagram 1200 of a device 1205 that supports interference pattern measurement and signaling in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of interference pattern measurement and signaling as described herein. For example, the communications manager 1220 may include a reporting manager 1225 a configuration manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The reporting manager 1225 is capable of, configured to, or operable to support a means for obtaining a reporting message including information indicative of one or more interference patterns, the one or more interference patterns associated with one or more signals that interfere with a message transmitted via a physical downlink channel. The configuration manager 1230 is capable of, configured to, or operable to support a means for outputting a control message indicating a configuration for a set of multiple reference signals associated with estimation of an interference covariance matrix, where the configuration is based on the one or more interference patterns.

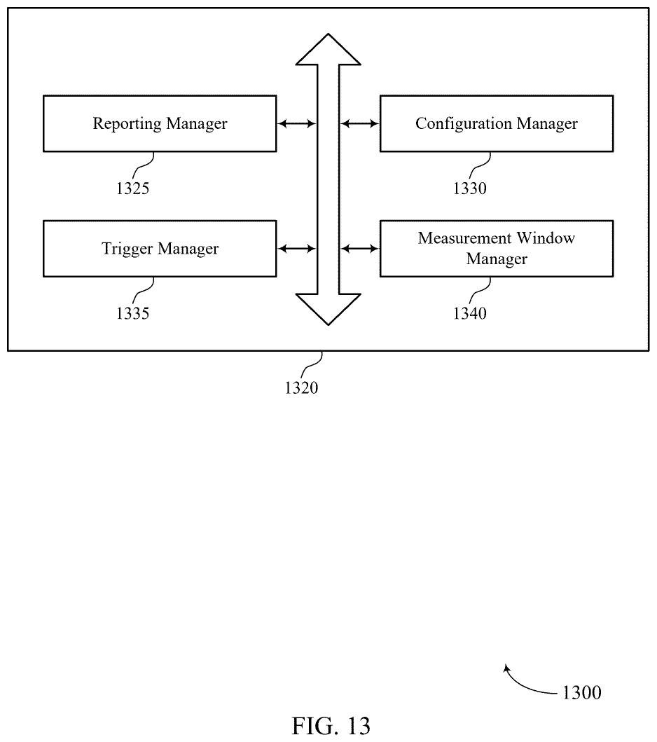

FIG. 13 shows a block diagram 1300 of a communications manager 1320 that supports interference pattern measurement and signaling in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of interference pattern measurement and signaling as described herein. For example, the communications manager 1320 may include a reporting manager 1325, a configuration manager 1330, a trigger manager 1335, a measurement window manager 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The reporting manager 1325 is capable of, configured to, or operable to support a means for obtaining a reporting message including information indicative of one or more interference patterns, the one or more interference patterns associated with one or more signals that interfere with a message transmitted via a physical downlink channel. The configuration manager 1330 is capable of, configured to, or operable to support a means for outputting a control message indicating a configuration for a set of multiple reference signals associated with estimation of an interference covariance matrix, where the configuration is based on the one or more interference patterns.

In some examples, the information indicative of the one or more interference patterns includes one or more time-domain averaging boundaries associated with one or more interference covariance matrix estimation computations of a UE. In some examples, the information indicative of the one or more interference patterns includes a bitmap indicating the one or more time-domain averaging boundaries for a set of multiple symbol periods associated with the physical downlink channel.

In some examples, to support obtaining the reporting message, the reporting manager 1325 is capable of, configured to, or operable to support a means for obtaining the reporting message in accordance with a periodicity.

In some examples, the trigger manager 1335 is capable of, configured to, or operable to support a means for outputting one or more messages that trigger a transmission of the reporting message, where the reporting message is obtained in accordance with the one or more messages. In some examples, the one or more messages include downlink control information, medium access control (MAC) control element messages, or any combination thereof.

In some examples, to support obtaining the reporting message, the reporting manager 1325 is capable of, configured to, or operable to support a means for obtaining the reporting message in accordance with one or more event triggers being satisfied.

In some examples, the measurement window manager 1340 is capable of, configured to, or operable to support a means for outputting one or more control messages indicating a configuration of one or more interference measurement windows, where the reporting message is based on the configuration of the one or more interference measurement windows.

In some examples, the configuration is for a link of a set of one or more links, the configuration including one or more time-domain locations of the set of multiple reference signals, a time density of the set of multiple reference signals, a frequency density of the set of multiple reference signals, one or more offsets associated with the set of multiple reference signals, or any combination thereof. In some examples, the configuration is from a set of multiple configurations for the set of multiple reference signals. In some examples, the control message includes downlink control information or an RRC message.

In some examples, to support obtaining the reporting message, the reporting manager 1325 is capable of, configured to, or operable to support a means for obtaining the reporting message via uplink control information or via one or more medium access control (MAC) control elements, or any combination thereof.

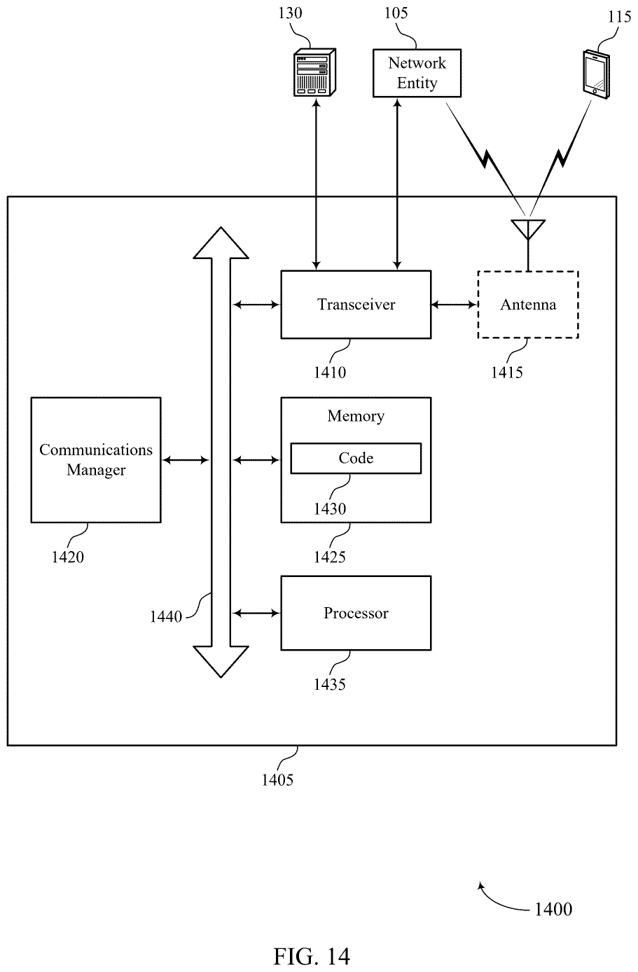

FIG. 14 shows a diagram of a system 1400 including a device 1405 that supports interference pattern measurement and signaling in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting interference pattern measurement and signaling). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for obtaining a reporting message including information indicative of one or more interference patterns, the one or more interference patterns associated with one or more signals that interfere with a message transmitted via a physical downlink channel. The communications manager 1420 is capable of, configured to, or operable to support a means for outputting a control message indicating a configuration for a set of multiple reference signals associated with estimation of an interference covariance matrix, where the configuration is based on the one or more interference patterns.

By including or configuring the communications manager 1420 in accordance with examples as described herein, the device 1405 may support techniques for improved communication reliability, reduced latency, improved user experience related to improved communication reliability, reduced power consumption, more efficient utilization of communication resources, and improved coordination between devices, among other examples.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of interference pattern measurement and signaling as described herein, or the at least one processor 1435 and the at least one memory 1425 may be otherwise configured to, individually or collectively, perform or support such operations.

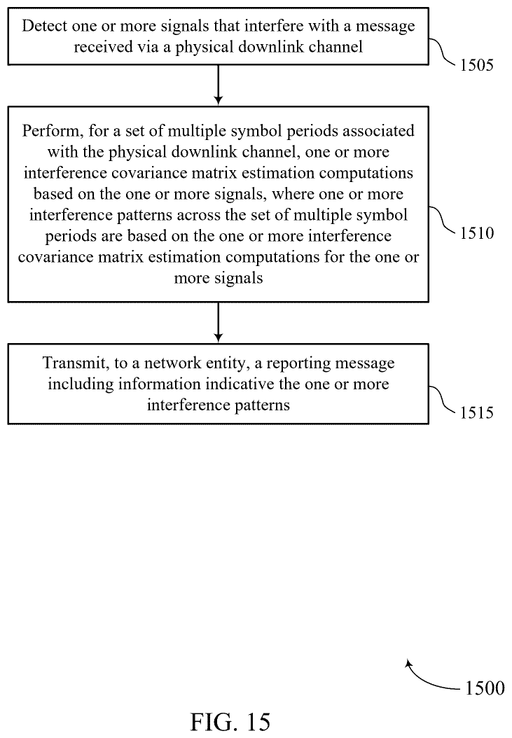

FIG. 15 shows a flowchart illustrating a method 1500 that supports interference pattern measurement and signaling in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include detecting one or more signals that interfere with a message received via a physical downlink channel. The operations of 1505 may be performed in accordance with examples as disclosed herein. In some examples, aspects of the operations of 1505 may be performed by an interference manager 925 as described with reference to FIG. 9.

At 1510, the method may include performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The operations of 1510 may be performed in accordance with examples as disclosed herein. In some examples, aspects of the operations of 1510 may be performed by a covariance matrix component 930 as described with reference to FIG. 9.

At 1515, the method may include transmitting, to a network entity, a reporting message including information indicative of the one or more interference patterns. The operations of 1515 may be performed in accordance with examples as disclosed herein. In some examples, aspects of the operations of 1515 may be performed by a reporting component 935 as described with reference to FIG. 9.

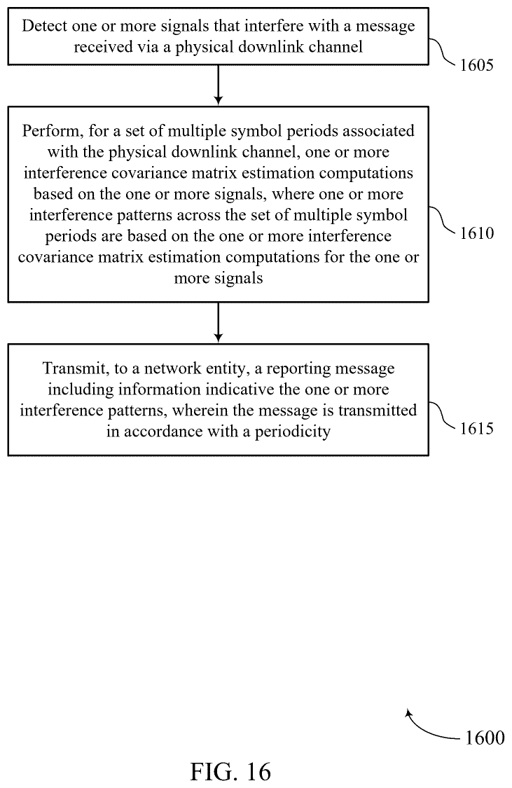

FIG. 16 shows a flowchart illustrating a method 1600 that supports interference pattern measurement and signaling in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include detecting one or more signals that interfere with a message received via a physical downlink channel. The operations of 1605 may be performed in accordance with examples as disclosed herein. In some examples, aspects of the operations of 1605 may be performed by an interference manager 925 as described with reference to FIG. 9.

At 1610, the method may include performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The operations of 1610 may be performed in accordance with examples as disclosed herein. In some examples, aspects of the operations of 1610 may be performed by a covariance matrix component 930 as described with reference to FIG. 9.

At 1615, the method may include transmitting the reporting message in accordance with a periodicity. The operations of 1615 may be performed in accordance with examples as disclosed herein. In some examples, aspects of the operations of 1615 may be performed by a reporting component 935 as described with reference to FIG. 9.

At 1620, the method may include transmitting, to a network entity, a reporting message including information indicative of the one or more interference patterns. The operations of 1620 may be performed in accordance with examples as disclosed herein. In some examples, aspects of the operations of 1620 may be performed by a reporting component 935 as described with reference to FIG. 9.

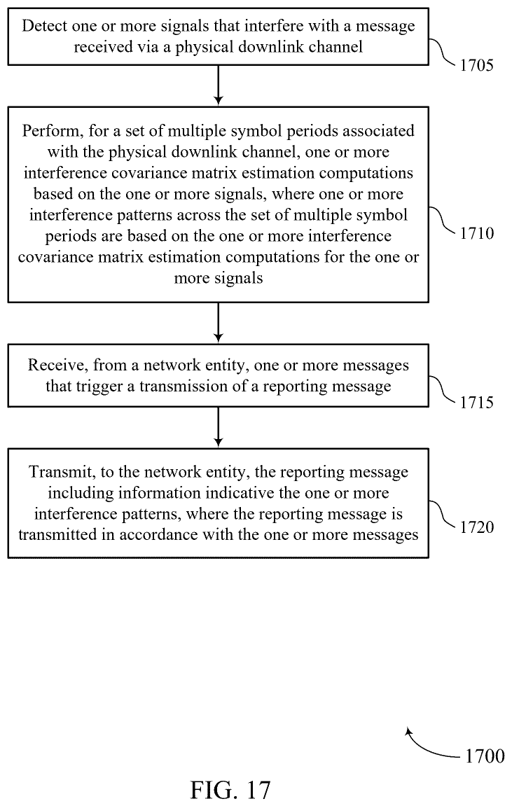

FIG. 17 shows a flowchart illustrating a method 1700 that supports interference pattern measurement and signaling in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include detecting one or more signals that interfere with a message received via a physical downlink channel. The operations of 1705 may be performed in accordance with examples as disclosed herein. In some examples, aspects of the operations of 1705 may be performed by an interference manager 925 as described with reference to FIG. 9.

At 1710, the method may include performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The operations of 1710 may be performed in accordance with examples as disclosed herein. In some examples, aspects of the operations of 1710 may be performed by a covariance matrix component 930 as described with reference to FIG. 9.

At 1715, the method may include receiving, from the network entity, one or more messages that trigger a transmission of the reporting message, where the reporting message is transmitted in accordance with the one or more messages. The operations of 1715 may be performed in accordance with examples as disclosed herein. In some examples, aspects of the operations of 1715 may be performed by a trigger component 940 as described with reference to FIG. 9.

At 1720, the method may include transmitting, to a network entity, a reporting message including information indicative of the one or more interference patterns. The operations of 1720 may be performed in accordance with examples as disclosed herein. In some examples, aspects of the operations of 1720 may be performed by a reporting component 935 as described with reference to FIG. 9.

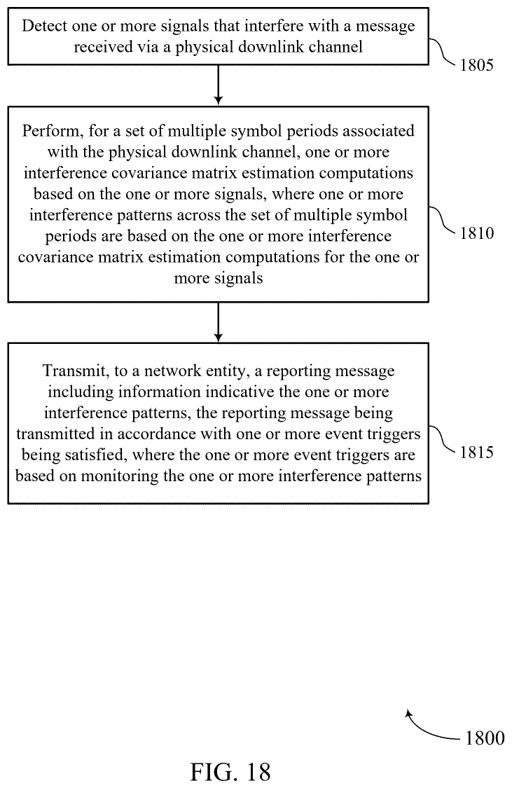

FIG. 18 shows a flowchart illustrating a method 1800 that supports interference pattern measurement and signaling in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include detecting one or more signals that interfere with a message received via a physical downlink channel. The operations of 1805 may be performed in accordance with examples as disclosed herein. In some examples, aspects of the operations of 1805 may be performed by an interference manager 925 as described with reference to FIG. 9.

At 1810, the method may include performing, for a set of multiple symbol periods associated with the physical downlink channel, one or more interference covariance matrix estimation computations based on the one or more signals, where one or more interference patterns across the set of multiple symbol periods are based on the one or more interference covariance matrix estimation computations for the one or more signals. The operations of 1810 may be performed in accordance with examples as disclosed herein. In some examples, aspects of the operations of 1810 may be performed by a covariance matrix component 930 as described with reference to FIG. 9.

At 1815, the method may include transmitting the reporting message in accordance with one or more event triggers being satisfied, where the one or more event triggers are based on monitoring the one or more interference patterns. The operations of 1815 may be performed in accordance with examples as disclosed herein. In some examples, aspects of the operations of 1815 may be performed by a reporting component 935 as described with reference to FIG. 9.

At 1820, the method may include transmitting, to a network entity, a reporting message including information indicative of the one or more interference patterns. The operations of 1820 may be performed in accordance with examples as disclosed herein. In some examples, aspects of the operations of 1820 may be performed by a reporting component 935 as described with reference to FIG. 9.

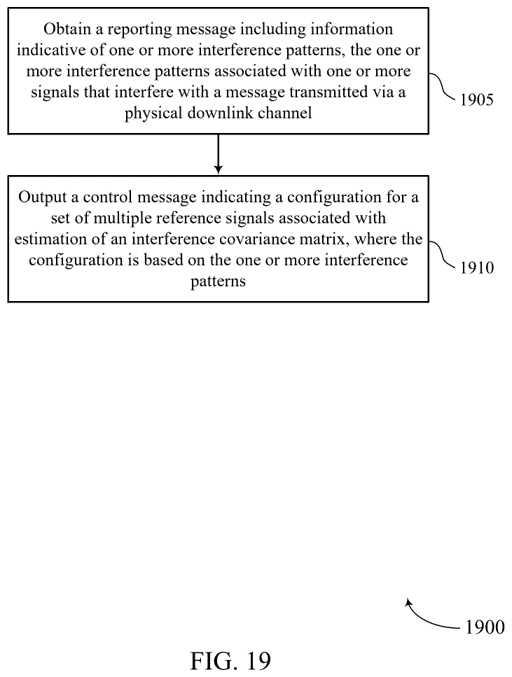

FIG. 19 shows a flowchart illustrating a method 1900 that supports interference pattern measurement and signaling in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining a reporting message including information indicative of one or more interference patterns, the one or more interference patterns associated with one or more signals that interfere with a message transmitted via a physical downlink channel. The operations of 1905 may be performed in accordance with examples as disclosed herein. In some examples, aspects of the operations of 1905 may be performed by a reporting manager 1325 as described with reference to FIG. 13.

At 1910, the method may include outputting a control message indicating a configuration for a set of multiple reference signals associated with estimation of an interference covariance matrix, where the configuration is based on the one or more interference patterns. The operations of 1910 may be performed in accordance with examples as disclosed herein. In some examples, aspects of the operations of 1910 may be performed by a configuration manager 1330 as described with reference to FIG. 13.

The following provides an overview of aspects of the present disclosure:
Aspect 1: A method for wireless communications at a UE, comprising: detecting one or more signals that interfere with a message received via a physical downlink channel; performing, for a plurality of symbol periods associated with the physical downlink channel, one or more interference covariance matrix estimation computations based at least in part on the one or more signals, wherein one or more interference patterns across the plurality of symbol periods is based at least in part on the one or more interference covariance matrix estimation computations for the one or more signals; and transmitting, to a network entity, a reporting message comprising information indicative the one or more interference patterns.
Aspect 2: The method of aspect 1, wherein the information indicative the one or more interference patterns comprises one or more time-domain averaging boundaries associated with the one or more interference covariance matrix estimation computations.
Aspect 3: The method of aspect 2, wherein the information indicative the one or more interference patterns comprises a bitmap indicating the one or more time-domain averaging boundaries for the plurality of symbol periods.
Aspect 4: The method of aspect 1, wherein transmitting the reporting message comprises: transmitting the reporting message in accordance with a periodicity.
Aspect 5: The method of aspect 1, further comprising: receiving, from the network entity, one or more messages that trigger a transmission of the reporting message, wherein the reporting message is transmitted in accordance with the one or more messages.
Aspect 6: The method of aspect 5, wherein the one or more messages comprise downlink control information, medium access control (MAC) control element messages, or any combination thereof.
Aspect 7: The method of aspect 1, wherein transmitting the reporting message comprises: transmitting the reporting message in accordance with one or more event triggers being satisfied, wherein the one or more event triggers are based at least in part on monitoring the one or more interference patterns.
Aspect 8: The method of any of aspects 1 through 7, further comprising: monitoring for the one or more signals during one or more interference measurement windows, wherein the one or more signals are detected in accordance with the monitoring.
Aspect 9: The method of aspect 8, further comprising: receiving, from the network entity, one or more control messages indicating a configuration of the one or more interference measurement windows, wherein the monitoring is based at least in part on the configuration.
Aspect 10: The method of any of aspects 1 through 7, further comprising: monitoring for the one or more signals during an interference measurement window, wherein the one or more signals are detected in accordance with the monitoring, and wherein the interference measurement window ends a first time offset before transmitting the reporting message.
Aspect 11: The method of aspect 10, wherein a beginning of the interference measurement window starts a second time offset after one or more event triggers are satisfied.
Aspect 12: The method of any of aspects 1 through 11, further comprising: receiving, from the network entity, a control message indicating a configuration for a plurality of reference signals associated with estimation of an interference covariance matrix, wherein the configuration is based at least in part on the one or more interference patterns.
Aspect 13: The method of aspect 12, wherein the configuration is for a link of a set of one or more links, the configuration comprising one or more time-domain locations of the plurality of reference signals, a time density of the plurality of reference signals, a frequency density of the plurality of reference signals, one or more offsets associated with the plurality of reference signals, or any combination thereof.
Aspect 14: The method of aspect 13, wherein the configuration is from a plurality of configurations for the plurality of reference signals.
Aspect 15: The method of any of aspects 12 through 14, wherein the control message comprises downlink control information or an RRC message.
Aspect 16: The method of any of aspects 1 through 15, wherein transmitting the reporting message comprises: transmitting the reporting message via uplink control information.
Aspect 17: The method of any of aspects 1 through 16, wherein transmitting the reporting message comprises: transmitting the reporting message via one or more medium access control (MAC) control elements.
Aspect 18: A method for wireless communications at a network entity, comprising: obtaining a reporting message comprising information indicative of one or more interference patterns, the one or more interference patterns associated with one or more signals that interfere with a message transmitted via a physical downlink channel; and outputting a control message indicating a configuration for a plurality of reference signals associated with estimation of an interference covariance matrix, wherein the configuration is based at least in part on the one or more interference patterns.
Aspect 19: The method of aspect 18, wherein the information indicative the one or more interference patterns comprises one or more time-domain averaging boundaries associated with one or more interference covariance matrix estimation computations of a UE.
Aspect 20: The method of aspect 19, wherein the information indicative the one or more interference patterns comprises a bitmap indicating the one or more time-domain averaging boundaries for a plurality of symbol periods associated with the physical downlink channel.
Aspect 21: The method of aspect 18, wherein obtaining the reporting message comprises: obtaining the reporting message in accordance with a periodicity.
Aspect 22: The method of aspect 18, further comprising: outputting one or more messages that trigger a transmission of the reporting message, wherein the reporting message is obtained in accordance with the one or more messages.
Aspect 23: The method of aspect 22, wherein the one or more messages comprise downlink control information, medium access control (MAC) control element messages, or any combination thereof.
Aspect 24: The method of aspect 18, wherein obtaining the reporting message comprises: obtaining the reporting message in accordance with one or more event triggers being satisfied.
Aspect 25: The method of any of aspects 18 through 24, further comprising: outputting one or more control messages indicating a configuration of one or more interference measurement windows, wherein the reporting message is based at least in part on the configuration of the one or more interference measurement windows.
Aspect 26: The method of any of aspects 18 through 25, wherein the configuration is for a link of a set of one or more links, the configuration comprising one or more time-domain locations of the plurality of reference signals, a time density of the plurality of reference signals, a frequency density of the plurality of reference signals, one or more offsets associated with the plurality of reference signals, or any combination thereof.
Aspect 27: The method of aspect 26, wherein the configuration is from a plurality of configurations for the plurality of reference signals.
Aspect 28: The method of any of aspects 26 through 27, wherein the control message comprises downlink control information or an RRC message.
Aspect 29: The method of any of aspects 18 through 28, wherein obtaining the reporting message comprises: obtaining the reporting message via uplink control information or via one or more medium access control (MAC) control elements, or any combination thereof.
Aspect 30: An apparatus for wireless communications at a UE, comprising one or more processors and instructions stored in one or more memories and executable by the one or more processors, individually or collectively, to cause the apparatus to perform a method of any of aspects 1 through 17.
Aspect 31: A UE for wireless communications, comprising at least one means for performing a method of any of aspects 1 through 17.
Aspect 32: A non-transitory computer-readable medium storing code for wireless communications, the code comprising instructions executable by one or more processors to perform a method of any of aspects 1 through 17.
Aspect 33: An apparatus wireless communications at a network entity, comprising one or more processors and instructions stored in one or more memories and executable by the one or more processors, individually or collectively, to cause the apparatus to perform a method of any of aspects 18 through 29.
Aspect 34: A network entity for wireless communications, comprising at least one means for performing a method of any of aspects 18 through 29.
Aspect 35: A non-transitory computer-readable medium storing code for wireless communications, the code comprising instructions executable by one or more processors to perform a method of any of aspects 18 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors; and
instructions stored in one or more memories and executable by the one or more processors, individually or collectively, to cause the apparatus to:
detect one or more signals that interfere with a message received via a physical downlink channel;
perform, for a plurality of symbol periods associated with the physical downlink channel, one or more interference covariance matrix estimation computations based at least in part on the one or more signals, wherein one or more interference patterns across the plurality of symbol periods are based at least in part on the one or more interference covariance matrix estimation computations for the one or more signals; and
transmit, to a network entity, a reporting message comprising information indicative of the one or more interference patterns.

2. The UE of claim 1, wherein the information indicative of the one or more interference patterns comprises one or more time-domain averaging boundaries associated with the one or more interference covariance matrix estimation computations.

3. The UE of claim 2, wherein the information indicative of the one or more interference patterns comprises a bitmap indicating the one or more time-domain averaging boundaries for the plurality of symbol periods.

4. The UE of claim 1, wherein, to transmit the reporting message, the instructions are executable by the one or more processors, individually or collectively, to cause the apparatus to:
transmit the reporting message in accordance with a periodicity.

5. The UE of claim 1, wherein the instructions are executable by the one or more processors, individually or collectively, to cause the apparatus to:
receive, from the network entity, one or more messages that trigger a transmission of the reporting message, wherein the reporting message is transmitted in accordance with the one or more messages.

6. The UE of claim 5, wherein the one or more messages comprise downlink control information, medium access control (MAC) control element messages, or any combination thereof.

7. The UE of claim 1, wherein, to transmit the reporting message, the instructions are executable by the one or more processors, individually or collectively, to cause the apparatus to:
transmit the reporting message in accordance with one or more event triggers being satisfied, wherein the one or more event triggers are based at least in part on monitoring the one or more interference patterns.

8. The UE of claim 1, wherein the instructions are executable by the one or more processors, individually or collectively, to cause the apparatus to:
monitor for the one or more signals during one or more interference measurement windows, wherein the one or more signals are detected in accordance with the monitoring.

9. The UE of claim 8, wherein the instructions are executable by the one or more processors, individually or collectively, to cause the apparatus to:
receive, from the network entity, one or more control messages indicating a configuration of the one or more interference measurement windows, wherein the monitoring is based at least in part on the configuration.

10. The UE of claim 1, wherein the instructions are executable by the one or more processors, individually or collectively, to cause the apparatus to:
monitor for the one or more signals during an interference measurement window, wherein the one or more signals are detected in accordance with the monitoring, and wherein the interference measurement window ends a first time offset before transmitting the reporting message.

11. The UE of claim 10, wherein a beginning of the interference measurement window starts a second time offset after one or more event triggers are satisfied.

12. The UE of claim 1, wherein the instructions are executable by the one or more processors, individually or collectively, to cause the apparatus to:
receive, from the network entity, a control message indicating a configuration for a plurality of reference signals associated with estimation of an interference covariance matrix, wherein the configuration is based at least in part on the one or more interference patterns.

13. The UE of claim 12, wherein the configuration is for a link of a set of one or more links, the configuration comprising one or more time-domain locations of the plurality of reference signals, a time density of the plurality of reference signals, a frequency density of the plurality of reference signals, one or more offsets associated with the plurality of reference signals, or any combination thereof.

14. The UE of claim 13, wherein the configuration is from a plurality of configurations for the plurality of reference signals.

15. The UE of claim 12, wherein the control message comprises downlink control information or a radio resource control (RRC) message.

16. The UE of claim 1, wherein, to transmit the reporting message, the instructions are executable by the one or more processors, individually or collectively, to cause the apparatus to:
transmit the reporting message via uplink control information.

17. The UE of claim 1, wherein, to transmit the reporting message, the instructions are executable by the one or more processors, individually or collectively, to cause the apparatus to:
transmit the reporting message via one or more medium access control (MAC) control elements.

18. An apparatus for wireless communications at a network entity, comprising:
one or more processors; and
instructions stored in one or more memories and executable by the one or more processors, individually or collectively, to cause the apparatus to:
obtain a reporting message comprising information indicative of one or more interference patterns, the one or more interference patterns associated with one or more signals that interfere with a message transmitted via a physical downlink channel; and
output a control message indicating a configuration for a plurality of reference signals associated with estimation of an interference covariance matrix, wherein the configuration is based at least in part on the one or more interference patterns.

19. The network entity of claim 18, wherein the information indicative of the one or more interference patterns comprises one or more time-domain averaging boundaries associated with one or more interference covariance matrix estimation computations of a user equipment (UE).

20. The network entity of claim 19, wherein the information indicative of the one or more interference patterns comprises a bitmap indicating the one or more time-domain averaging boundaries for a plurality of symbol periods associated with the physical downlink channel.

21. The network entity of claim 18, wherein, to obtain the reporting message, the instructions are executable by the one or more processors, individually or collectively, to cause the apparatus to:
obtain the reporting message in accordance with a periodicity.

22. The network entity of claim 18, wherein the instructions are executable by the one or more processors, individually or collectively, to cause the apparatus to:
output one or more messages that trigger a transmission of the reporting message, wherein the reporting message is obtained in accordance with the one or more messages.

23. The network entity of claim 22, wherein the one or more messages comprise downlink control information, medium access control (MAC) control element messages, or any combination thereof.

24. The network entity of claim 18, wherein, to obtain the reporting message, the instructions are executable by the one or more processors, individually or collectively, to cause the apparatus to:
obtain the reporting message in accordance with one or more event triggers being satisfied.

25. The network entity of claim 18, wherein the instructions are executable by the one or more processors, individually or collectively, to cause the apparatus to:
output one or more control messages indicating a configuration of one or more interference measurement windows, wherein the reporting message is based at least in part on the configuration of the one or more interference measurement windows.

26. The network entity of claim 18, wherein the configuration is for a link of a set of one or more links, the configuration comprising one or more time-domain locations of the plurality of reference signals, a time density of the plurality of reference signals, a frequency density of the plurality of reference signals, one or more offsets associated with the plurality of reference signals, or any combination thereof.

27. The network entity of claim 26, wherein the configuration is from a plurality of configurations for the plurality of reference signals.

28. The network entity of claim 18, wherein, to obtain the reporting message, the instructions are executable by the one or more processors, individually or collectively, to cause the apparatus to:
obtain the reporting message via uplink control information or via one or more medium access control (MAC) control elements, or any combination thereof.

29. A method for wireless communications at a user equipment (UE), comprising:
detecting one or more signals that interfere with a message received via a physical downlink channel;
performing, for a plurality of symbol periods associated with the physical downlink channel, one or more interference covariance matrix estimation computations based at least in part on the one or more signals, wherein one or more interference patterns across the plurality of symbol periods are based at least in part on the one or more interference covariance matrix estimation computations for the one or more signals; and
transmitting, to a network entity, a reporting message comprising information indicative of the one or more interference patterns.

30. A method for wireless communications at a network entity, comprising:
obtaining a reporting message comprising information indicative of one or more interference patterns, the one or more interference patterns associated with one or more signals that interfere with a message transmitted via a physical downlink channel; and
outputting a control message indicating a configuration for a plurality of reference signals associated with estimation of an interference covariance matrix, wherein the configuration is based at least in part on the one or more interference patterns.
